(19) United States
(12) Patent Application Publication
(10) Pub. No.: US 2025/0356583 A1
(43) Pub. Date: Nov. 20, 2025

(54) WEARABLE DEVICE, METHOD, AND NON-TRANSITORY COMPUTER READABLE STORAGE MEDIUM FOR RENDERING IMAGE

(71) Applicant: Samsung Electronics Co., Ltd., Suwon-si (KR)

(72) Inventors: Wonjoon DO, Suwon-si (KR); Sungoh KIM, Suwon-si (KR); Jinsung KIM, Suwon-si (KR); Sungryong PARK, Suwon-si (KR); Dongheon YOO, Suwon-si (KR); Beomsu KIM, Suwon-si (KR); Donghyun YEOM, Suwon-si (KR); Sanghun LEE, Suwon-si (KR)

(21) Appl. No.: 19/214,909

(22) Filed: May 21, 2025

Related U.S. Application Data
(63) Continuation of application No. PCT/KR2025/004506, filed on Apr. 3, 2025.

(30) Foreign Application Priority Data
May 20, 2024 (KR) 10-2024-0065350
Jul. 23, 2024 (KR) 10-2024-0097154
Sep. 24, 2024 (KR) 10-2024-0129465

(51) Int. Cl. G06T 17/00; G06F 3/01; G06T 5/20; G06T 5/70; G06T 5/73

(52) U.S. Cl. CPC G06T 17/00; G06F 3/013; G06T 5/20; G06T 5/70; G06T 5/73

(57) ABSTRACT

A wearable device includes memory storing instructions, at least one first camera, at least one second camera, display assembly including at least one display including a display region, and at least one processor. The at least one processor causes the wearable device to: identify an event for displaying a screen, based on the event for displaying the screen within at least a portion of the display region where a gaze of a user is located, according to rendering the image using depth values, display, within the at least a portion of the display region, the screen, and based on the event for displaying the screen outside of the at least a portion of the display region where the gaze is located, according to rendering the image using a portion of the depth values, display, outside of the at least a portion of the display region, the screen.

### CROSS-REFERENCE TO RELATED APPLICATIONS

This application is a continuation of International Application No. PCT/KR2025/004506 designating the United States, filed on Apr. 3, 2025, in the Korean Intellectual Property Receiving Office and claiming priority to Korean Patent Application Nos. 10-2024-0065350, filed on May 20, 2024, 10-2024-0097154, filed on Jul. 23, 2024, and 10-2024-0129465, filed on Sep. 24, 2024, in the Korean Intellectual Property Office, the disclosures of each of which are incorporated by reference herein in their entireties.

### BACKGROUND

### Field

The present disclosure relates to a wearable device, a method, and a non-transitory computer-readable storage medium for rendering an image.

### Description of Related Art

A wearable device may include a camera and a display. The wearable device may be used as a tool for implementing virtual reality, augmented reality, and mixed reality. The wearable device may display an image obtained through a camera on the display. The wearable device may provide a clear image by performing correction on an image obtained through a camera.

The above-described information may be provided as a related art for the purpose of helping to understand the present disclosure.

No claim or determination is made as to whether any of the above-described information may be applied as a prior art related to the present disclosure.

### SUMMARY

A wearable device is described. The wearable device may comprise memory, comprising one or more storage mediums, storing instructions. The wearable device may comprise at least one first camera. The wearable device may comprise at least one second camera. The wearable device may comprise display assembly including at least one display including a display region. The wearable device may comprise at least one processor comprising processing circuitry. The instructions, when executed by the at least one processor individually or collectively, may cause the wearable device to identify an event for displaying a screen generated using an image obtained through the at least one first camera. The instructions, when executed by the at least one processor individually or collectively, may cause the wearable device to, based on the event for displaying the screen within at least a portion of the display region where a gaze of a user identified through the at least one second camera is located, according to rendering the image using depth values obtained with respect to obtaining the image, display, within the at least a portion of the display region, the screen. The instructions, when executed by the at least one processor individually or collectively, may cause the wearable device to, based on the event for displaying the screen outside of the at least a portion of the display region where the gaze identified through the at least one second camera is located, according to rendering the image using a portion of the depth values, display, outside of the at least a portion of the display region, the screen.

A method is provided. The method may be executed in a wearable device with at least one first camera, at least one second camera, and display assembly including at least one display including a display region. The method may comprise identifying an event for displaying a screen generated using an image obtained through the at least one first camera. The method may comprise, based on the event for displaying the screen within at least a portion of the display region where a gaze of a user identified through the at least one second camera is located, according to rendering the image using depth values obtained with respect to obtaining the image, displaying, within the at least a portion of the display region, the screen. The method may comprise, based on the event for displaying the screen outside of the at least a portion of the display region where the gaze identified through the at least one second camera is located, according to rendering the image using a portion of the depth values, displaying, outside of the at least a portion of the display region, the screen.

A non-transitory computer readable storage medium is provided. The non-transitory computer readable storage medium may store one or more programs. The one or more programs may comprise instructions to, when executed by a wearable device with at least one first camera, at least one second camera, and display assembly including at least one display including a display region, cause the wearable device to identify an event for displaying a screen generated using an image obtained through the at least one first camera. The one or more programs may comprise instructions to, when executed by the wearable device, cause the wearable device to, based on the event for displaying the screen within at least a portion of the display region where a gaze of a user identified through the at least one second camera is located, according to rendering the image using depth values obtained with respect to obtaining the image, display, within the at least a portion of the display region, the screen. The one or more programs may comprise instructions to, when executed by the wearable device, cause the wearable device to, based on the event for displaying the screen outside of the at least a portion of the display region where the gaze identified through the at least one second camera is located, according to rendering the image using a portion of the depth values, display, outside of the at least a portion of the display region, the screen.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example of an environment including a wearable device according to various embodiments;

FIG. 2 is a diagram illustrating an example of a wearable device displaying a screen according to various embodiments;

FIG. 3 is a block diagram illustrating an example configuration of an example wearable device according to various embodiments;

FIG. 4 is a flowchart illustrating an example method of displaying a screen according to various embodiments;

FIGS. 5A and 5B are diagrams illustrating an example of rendering an image according to various embodiments;

FIG. 6A is a diagram illustrating an example of describing features for each mode according to various embodiments;

FIG. 6B is a diagram illustrating an example of an event related to a recommended region according to various embodiments;

FIG. 7 is a diagram illustrating an example of an event related to content according to various embodiments;

FIG. 8 is a diagram illustrating an example of controlling a size of a region related to a foveated rendering mode according to various embodiments;

FIG. 9 is a block diagram illustrating an example electronic device in a network environment according to various embodiments;

FIG. 10A is a perspective view illustrating an example wearable device according to various embodiments;

FIG. 10B is a perspective view illustrating an example of one or more hardware disposed in a wearable device according to various embodiments;

FIGS. 11A and 11B are perspective views illustrating an example of an exterior of a wearable device according to various embodiments;

FIG. 12 is a block diagram illustrating an example configuration of a wearable device according to various embodiments; and

FIG. 13 is a block diagram illustrating an example configuration of an electronic device for displaying an image in a virtual space according to various embodiments.

### DETAILED DESCRIPTION

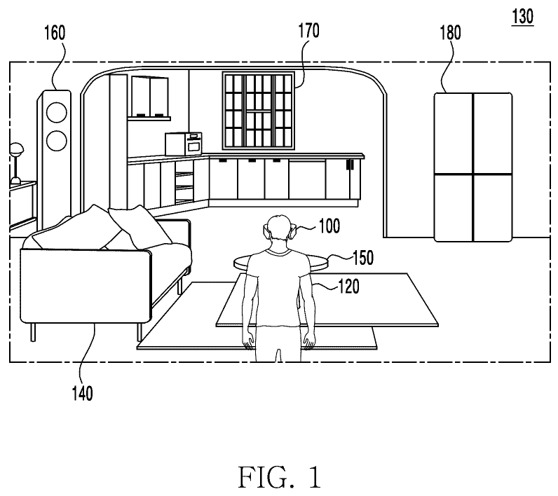

FIG. 1 is a diagram illustrating an example of an environment including a wearable device according to various embodiments.

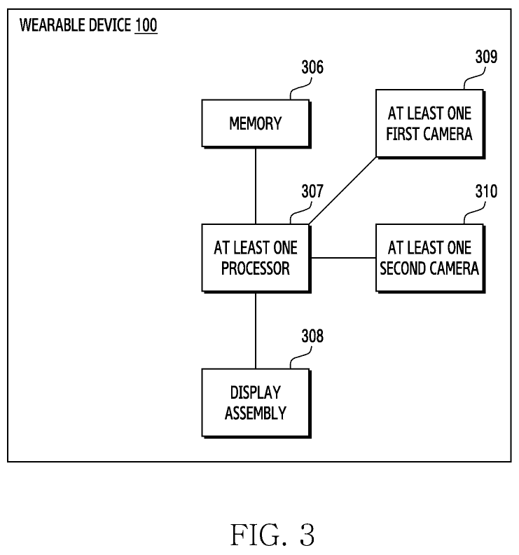

Referring to FIG. 1, a wearable device 100 may be used to provide a three-dimensional (3D) environment. For example, the wearable device 100 may be worn by a user 120. For example, the wearable device 100 may be worn on a head of the user 120. For example, the wearable device 100 may be referred to as a head-wearable electronic device. For example, the wearable device 100 may include display assembly (e.g., the display assembly 308 of FIG. 3). For example, the wearable device 100 may provide an image corresponding to an external environment through the display assembly. For example, the wearable device 100 may provide an image obtained through at least one first camera (e.g., the at least one first camera 309 of FIG. 3) through the display assembly.

According to an embodiment, an environment 130 may include the user 120, the wearable device 100, a sofa 140, a table 150, an air conditioner 160, a refrigerator 180, and/or a window 170. For example, the wearable device 100 may obtain an image of the environment 130 through the at least one first camera. For example, the wearable device 100 may provide the image obtained through the at least one first camera through the display assembly. For example, the wearable device 100 may provide or execute a pass-through function. For example, the pass-through function may be described as a function of providing a visual object corresponding to the external environment of the wearable device 100 through the display assembly. For example, the pass-through function may be described as a function of providing an image obtained through at least one first camera (e.g., the at least one first camera 309 of FIG. 3) of the wearable device 100 through display assembly (e.g., the display assembly 308 of FIG. 3). For example, the wearable device 100 may provide the user 120 with a user experience while wearing the wearable device 100, such as viewing the environment 130 with eyes of the user 120, by displaying images of the environment 130 obtained through at least one first camera (e.g., the at least one first camera 309 of FIG. 3) in real time through display assembly (e.g., the display assembly 308 of FIG. 3), based on executing the pass-through function.

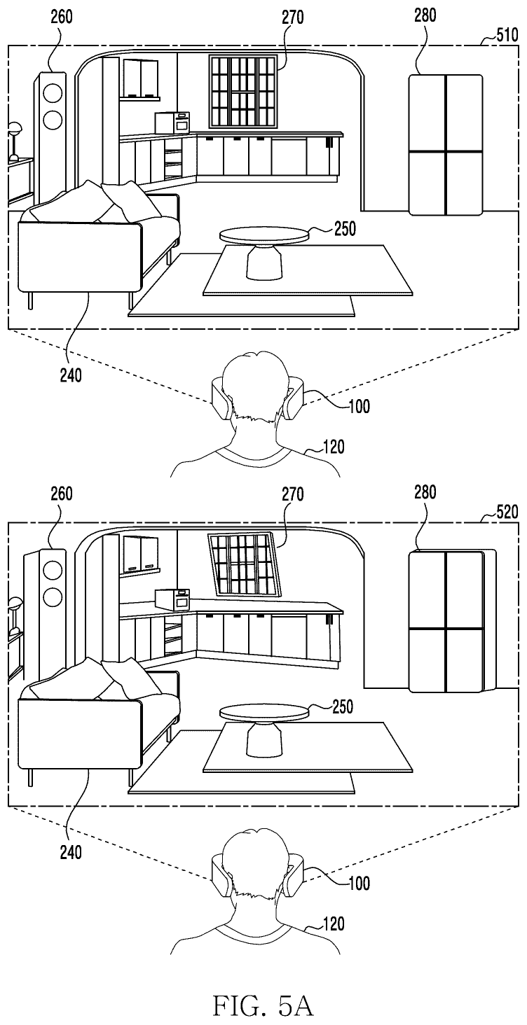

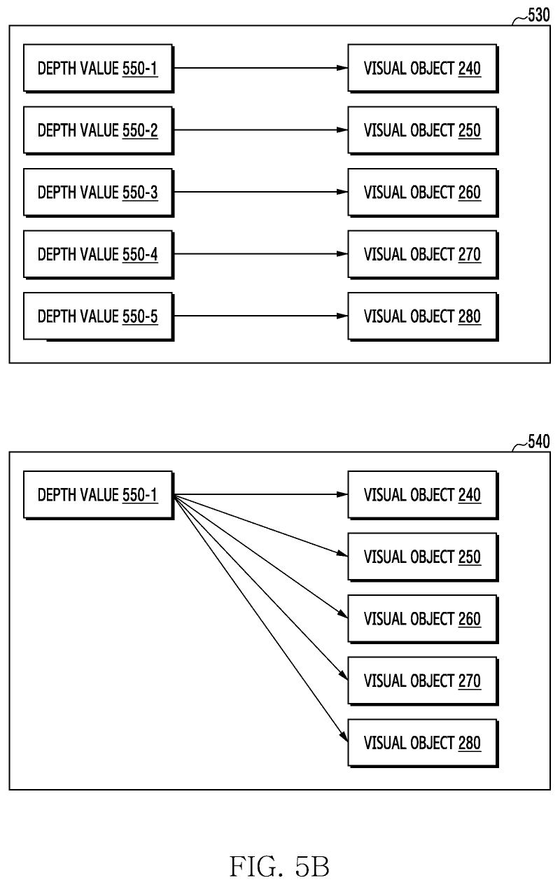

A scene of the environment 130 viewed through the eyes of the user 120 may differ from images of the environment 130 provided as the wearable device 100 executes the pass-through function. For example, as a difference between the scene and the images increases, the user 120 may feel dizziness. For example, in order to prevent and/or reduce dizziness, the wearable device 100 may be required to provide images similar to the scene. For example, the wearable device 100 may perform image processing techniques to provide images similar to the scene. For example, the image processing techniques may include resolution enhancement, noise removal, brightness adjustment, and color tuning. For example, the image processing techniques may include minimizing and/or reducing spatial distortion. For example, the wearable device 100 may apply respectively depth values (e.g., the depth values 550 of FIG. 5B) to each of objects included in the images (e.g., visual objects 240 to 280 of FIG. 5B) to minimize and/or reduce the spatial distortion. For example, a technique minimizing and/or reducing the spatial distortion may be explained by performing interpolation on the edge of each of the objects. For example, as the interpolation is performed, the spatial distortion may occur. For example, the user 120 may perceive the dizziness due to the spatial distortion. For example, the wearable device 100 may provide images similar to the scene to the user 120, by applying the depth values to the objects.

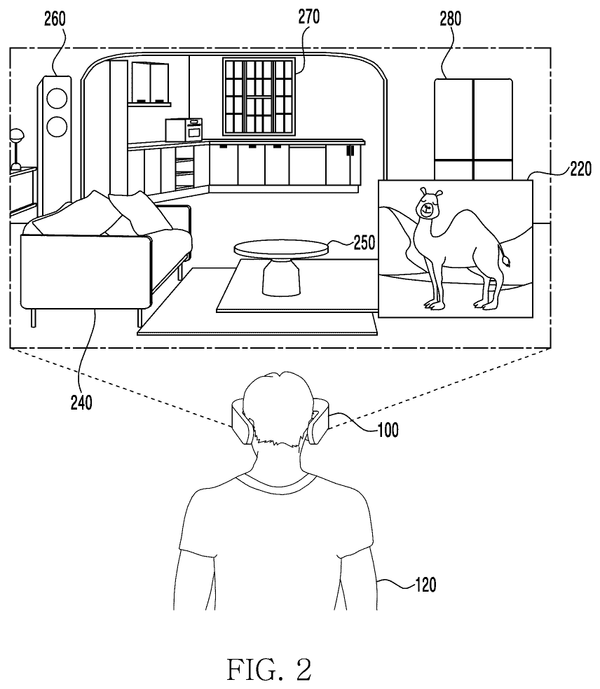

According to an embodiment, the wearable device 100 may provide or display an image of an external environment through the display assembly. For example, the display assembly may include at least one opaque display. For example, since the display assembly includes the at least one opaque display, the wearable device 100 may be required to provide an image of the environment 130 through the display assembly. For example, the wearable device 100 may provide content (e.g., the content 220 of FIG. 2) while providing an image of the environment 130 through the display assembly. The provision of the image and content is described and illustrated in greater detail below with reference to FIG. 2.

FIG. 2 is a diagram illustrating an example of a wearable device displaying a screen according to various embodiments.

Referring to FIG. 2, the wearable device 100 may provide content 220 through display assembly (e.g., the display assembly 308 of FIG. 3) while providing a pass-through function. For example, a state 210 may be described as a state in which the content 220 is displayed while the pass-through function is executed through the display assembly. For example, the wearable device 100 may provide the content 220 while providing an image or screen corresponding to the environment 130 through the display assembly. For example, the wearable device 100 may provide the content 220 by overlapping an image or screen corresponding to the environment 130. However, the disclosure is not limited thereto. For example, the wearable device 100 may execute a software application (e.g., a software application for a video, a software application for a call, and a software application for a game) while providing a visual object for the content 220 and the environment 130 through the display assembly. For example, the wearable device 100 may control at least one first camera (e.g., the at least one first camera 309 of FIG. 3) to provide a pass-through function. For example, the wearable device 100 may control at least one second camera (e.g., the at least one second camera 310 of FIG. 3) to provide a pass-through function.

According to an embodiment, the wearable device 100 may provide, through the display assembly, a visual object for the environment 130 using the pass-through function. For example, a sofa 140 may correspond to a visual object 240. For example, a table 150 may correspond to a visual object 250. For example, an air conditioner 160 may correspond to a visual object 260. For example, a window 170 may correspond to a visual object 270. For example, a refrigerator 180 may correspond to a visual object 280. The wearable device 100 may provide immersiveness to the user 120 by providing at least one visual object (e.g., the visual object 240 to the visual object 280) through the display assembly.

According to an embodiment, the power consumed by the wearable device 100 for providing the content 220 may be less than the power consumed by the wearable device 100 for providing visual objects (e.g., the visual object 240 to the visual object 280) for the content 220 and the environment 130. For example, a resource required for the wearable device 100 to provide visual objects for the content 220 and the environment 130 may be more than a resource required for the wearable device 100 to provide the content 220. For example, when the user 120 focuses on the content 220, it may be required to reduce the resource consumed by the wearable device 100 to provide a pass-through function. For example, when the user 120 focuses on the content 220, the wearable device 100 may be required to reduce the power consumed to provide a visual object corresponding to the environment 130 through the display assembly. For example, the wearable device 100 may perform image processing techniques to provide images for the environment 130, which are similar to those seen by eyes of the user 120, through display assembly (e.g., the display assembly 308 of FIG. 3). For example, the image processing techniques may include resolution enhancement, noise removal, brightness adjustment, and/or color tuning. For example, the image processing techniques may include interpolation for an object to minimize and/or reduce spatial distortion. For example, the image processing techniques may include an improvement in a frame speed of at least one first camera 309. For example, the image processing techniques may include a technique of applying respectively depth values to each of the visual objects (e.g., the visual object 240 to the visual object 280) included in images. For example, the wearable device 100 may use at least one processor (e.g., the at least one processor 307 of FIG. 3) to perform the image processing techniques. For example, the wearable device 100 may be required to simultaneously execute a plurality of tracking functions (e.g., head tracking function, hand tracking function, gaze tracking function, face tracking function) and a software application for the content 220 to provide the pass-through function. For example, the wearable device 100 may use a large amount of resources to provide the pass-through function in which the image processing techniques are performed. For example, the wearable device 100 may use a large amount of power to provide the pass-through function in which the image processing techniques are performed. For example, it may require a large amount of computation for the wearable device 100 to perform the functions and the techniques. For example, the wearable device 100 may be required to reduce resources and power consumed by the wearable device 100.

For example, the wearable device 100 may change a method of providing the pass-through function when the user 120 focuses on the content 220. For example, when the user 120 focuses on the environment 130, the wearable device 100 may provide a screen generated using the image through the display assembly, according to rendering an image using depth values obtained with respect to the image obtained through at least one first camera (e.g., the at least one first camera 309 of FIG. 3). For example, when the user 120 focuses on the content 220, the wearable device 100 may provide a screen generated using the image through the display assembly according to rendering the image using some of the depth values obtained with respect to the image.

For example, the wearable device 100 may include hardware components used to perform or execute the operations. Various hardware components are described and illustrated in greater detail below with reference to FIG. 3.

FIG. 3 is a block diagram illustrating an example configuration of an example wearable device according to various embodiments.

Referring to FIG. 3, a wearable device 100 may include at least one processor (e.g., including processing circuitry) 307, memory 306, display assembly (e.g., including a display) 308, at least one first camera 309, and at least one second camera 310.

The at least one processor 307 may include a hardware component for processing data using instructions stored in the memory 306. The hardware component for processing data may include a central processing unit (CPU) (e.g., including processing circuitry). The hardware component for processing data may include a graphic processing unit (GPU) (e.g., including processing circuitry). The hardware component for processing data may include a display processing unit (DPU) (e.g., including processing circuitry). The hardware component for processing data may include a neural processing unit (NPU) (e.g., including processing circuitry).

According to an embodiment, the at least one processor 307 may include one or more cores. For example, the at least one processor 307 may have a structure of a multi-core processor such as a dual core, a quad core, or a hexa core. The at least one processor 307 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the memory 306 may include a hardware component for storing data and/or instructions input to and/or output from the at least one processor 307. For example, the memory 306 may include volatile memory such as random-access memory (RAM) and/or non-volatile memory such as read-only memory (ROM). For example, the volatile memory may include at least one of dynamic RAM (DRAM), static RAM (SRAM), cache RAM, and pseudo SRAM (PSRAM). For example, the non-volatile memory may include at least one of programmable ROM (PROM), erasable PROM (EPROM), electrically erasable PROM (EEPROM), flash memory, hard disk, compact disk, and embedded multimedia card (EMMC).

According to an embodiment, the display assembly 308 may include a display and output visualized information. For example, the display assembly 308 may output visualized information to a user according to the control of the at least one processor 307. The display assembly 308 may include a hardware component of the wearable device 100 used to display a screen. For example, the display assembly 308 may include light-emitting elements and circuits (e.g., transistors) that control the light-emitting elements to emit light. For example, each of the light emitting elements may include an organic light emitting diode (OLED) or a micro LED. However, the disclosure is not limited thereto. For example, the display assembly 308 may include a liquid crystal display (LCD).

According to an embodiment, the display assembly 308 may include a first display positioned in front of the left eye of the user wearing the wearable device 100 and a second display positioned in front of the right eye of the user wearing the wearable device 100. For example, a first content provided through a screen displayed through the first display may be (substantially) identical to a second content provided through a screen displayed through the second display. Although the first content and the second content are the same as each other, the screen displayed through the second display may have a disparity with respect to the screen displayed through the first display. For example, the disparity may cause the display assembly 308 to provide content (e.g., corresponding to the first content and the second content) in 3D.

As a non-limiting example, the at least one first camera 309 may include one or more optical sensors (e.g., a charged coupled device (CCD) sensor, a complementary metal oxide semiconductor (CMOS) sensor) that generate an electrical signal indicating color and/or brightness of light. For example, the at least one first camera 309 may be described as at least one image sensor. For example, the at least one first camera 309 may be available to obtain an image of the environment around the wearable device 100. For example, the at least one first camera 309 may have a field of view (FOV) corresponding to an FOV of the user's eyes. For example, the at least one first camera 309 may be used to obtain an image of the environment 130 around the wearable device 100. For example, the at least one first camera 309 may be referred to as a video see-through (VST) camera.

As a non-limiting example, the at least one second camera 310 may include one or more optical sensors (e.g., a charged coupled device (CCD) sensor, a complementary metal oxide semiconductor (CMOS) sensor) that generate an electrical signal indicating color and/or brightness of light. For example, the at least one second camera 310 may be described as at least one image sensor. For example, the at least one second camera 310 may be available to obtain an image of the environment around the wearable device 100. For example, the at least one second camera 310 may have a field of view (FOV) corresponding to an FOV of the user's eyes. For example, the at least one second camera 310 may be used to obtain an image for the user's 120 eye. For example, the at least one second camera 310 may be arranged with respect to the user's 120 eye.

As a non-limiting example, the at least one processor 307 may identify an event for displaying a screen generated using an image obtained through the at least one first camera 309. The at least one first camera 309 may be used to obtain an image for the environment 130. The display assembly 308 may include a display region. Based on an event for displaying a screen in at least a portion of a display region, the at least one processor 307 may display the screen in the at least a portion of the display region. Based on an event for displaying a screen outside at least a portion of a display region, the at least one processor 307 may display the screen outside the at least a portion of the display region. The at least one second camera 310 may be used to obtain an image of the user's 120 eye. The at least one processor 307 may identify a gaze of the user 120 using the image obtained through the at least one second camera 310. The at least one processor 307 may display a screen within or outside of at least a portion of the display assembly 308, based on identifying a location of the user's gaze.

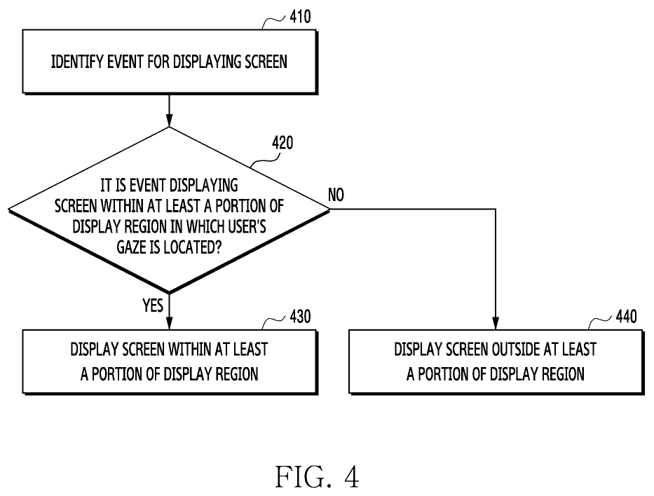

FIG. 4 is a flowchart illustrating an example method of displaying a screen according to various embodiments. This method may be executed by the wearable device 100 or the at least one processor 307 of the wearable device 100 illustrated in FIG. 3.

Referring to FIG. 4, in operation 410, at least one processor 307 may identify an event for displaying a screen generated using an image obtained through at least one first camera 309.

In operation 420, at least one processor 307 (e.g., determination module) may identify a location of a gaze of a user 120. The at least one processor 307 may execute operation 430 on a condition that is an event for displaying a screen within at least a portion of a display region in which the gaze of the user 120 is located, and execute operation 440 on a condition that is an event for displaying a screen outside at least a portion of a display region in which the gaze of the user 120 is located. For example, display assembly 308 may include a display region. For example, the display region may be described as a region in which a screen may be displayed on the display assembly 308. For example, the user 120 may gaze at least a portion of the display region. For example, the at least one processor 307 may identify a location of the gaze of the user 120 using an image obtained through at least one second camera 310. For example, the at least one processor 307 may identify whether the gaze of the user 120 is located within at least a portion of the display region. For example, the at least one processor 307 may determine a region of interest (ROI) based on a location of the gaze of the user 120. For example, the at least one processor 307 may determine that the user 120 is interested in content related to the gaze of the user 120, based on the gaze of the user 120. For example, the determination may be performed by the at least one processor 307 (e.g., a determination module).

In operation 430, based on an event for displaying a screen within at least a portion of a display region in which a gaze of the user 120 identified through the at least one second camera 310 is located, the at least one processor 307 may display a screen, within at least a portion of the display region, according to rendering the image using depth values obtained with respect to obtaining the image. For example, the at least one processor 307 may identify a location of a gaze of the user 120 through the at least one second camera 310. For example, the at least one processor 307 may identify an event for displaying a screen within at least a portion of the display region. For example, the at least one processor 307 may obtain depth values with respect to obtaining an image, based on the event. For example, the at least one processor 307 may render an image using the obtained depth values. For example, according to rendering the image, the at least one processor 307 may display a screen generated using an image obtained through the at least one first camera 309 within at least a portion of the display region.

In operation 440, based on an event for displaying a screen outside at least a portion of the display region in which a gaze identified through the at least one second camera 310 is located, the at least one processor 307 may display the screen outside at least a portion of the display region, according to rendering the image using a portion of the depth values. For example, the at least one processor 307 may identify a location of the gaze of the user 120 through the at least one second camera 310. For example, the at least one processor 307 may identify an event for displaying a screen outside at least a portion of the display region in which the gaze of the user 120 is located. For example, the at least one processor 307 may render an image using a portion of the depth values obtained with respect to obtaining the image. For example, the at least one processor 307 may display a screen outside at least a portion of the display region, according to rendering the image.

The at least one processor 307 may determine at least a portion of the display region in which the gaze of the user 120 is located as ROI. For example, the at least one processor 307 may identify at least a portion of the display region to which the gaze of the user 120 is directed as ROI, based on the user's gaze being located within at least a portion of the display region. For example, the display region may be described as a region in which a screen may be displayed on the display assembly 308. For example, the at least one processor 307 may identify the gaze of the user 120 through at least one second camera 310. For example, the at least one processor 307 may perform an eye-tracking function through the at least one second camera 310. For example, the at least one processor 307 may determine that the user 120 is interested in the content displayed within at least a portion of the display region, based on the user's 120 gaze being directed to at least a portion of the display region. For example, the at least one processor 307 may determine that the user 120 focuses on the content displayed within at least a portion of the display region, based on the user's 120 gaze being directed to at least a portion of the display region.

The wearable device 100 may include a sensor (not illustrated). For example, the sensor may be used to identify movement of the wearable device 100. For example, the user 120 may move in a state of wearing the wearable device 100. For example, the at least one processor 307 may obtain data on the movement of the wearable device 100 through the sensor. For example, the at least one processor 307 may determine content that the user 120 is interested in using data on the movement of the wearable device 100. For example, the at least one processor 307 may identify a direction in which the wearable device 100 is directed using data on the movement of the wearable device 100. For example, the at least one processor 307 may perform a head-tracking function through the sensor. For example, the at least one processor 307 may determine the content that the user 120 is interested in among content provided through the display assembly 308, by identifying the direction in which the wearable device 100 is directed. For example, the at least one processor 307 may determine content that the user 120 is interested in using a gaze tracking function and a head tracking function. For example, the at least one processor 307 may use a gaze tracking function and a head tracking function to determine the content that the user 120 is focusing on among the content provided through the display assembly 308.

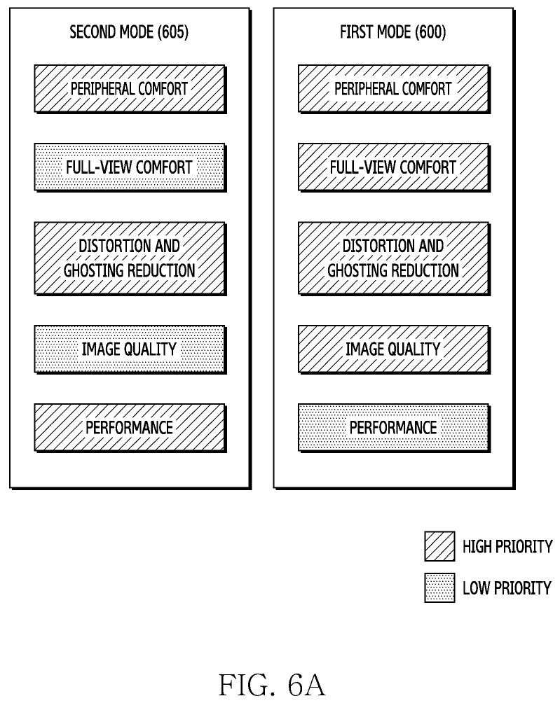

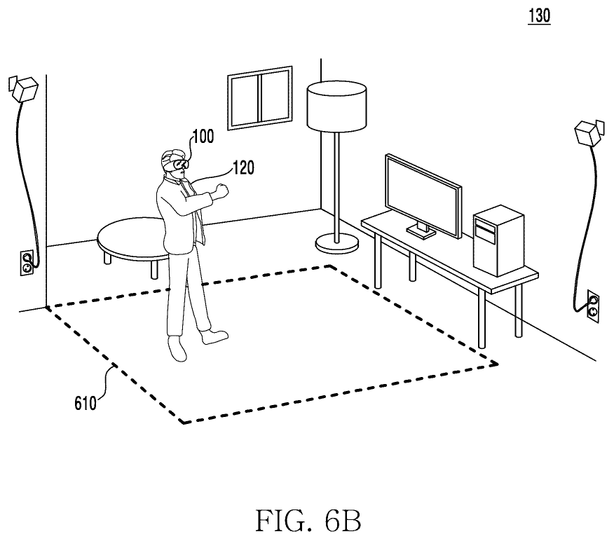

According to an embodiment, the wearable device 100 may manage a resource by changing a method of rendering an image based on an event. For example, the amount of resources consumed may be different in accordance with a method of rendering an image. For example, a resource consumed by the wearable device 100 to provide a pass-through function in a first mode (e.g., the first mode 600 of FIG. 6A) may be greater than a resource consumed by the wearable device 100 to provide the pass-through function in a second mode (e.g., the second mode 605 of FIG. 6A). For example, the first mode (e.g., the first mode 600 of FIG. 6A) may be referred to as a quality mode. For example, the second mode (e.g., the second mode 605 of FIG. 6A) may be referred to as an efficiency mode. For example, the first mode (e.g., the first mode 600 of FIG. 6A) may be described as a mode for operation 430. For example, the second mode (e.g., the second mode 605 of FIG. 6A) may be described as a mode for operation 440. For example, the wearable device 100 may provide another function using saved resources, by providing a pass-through function in the second mode (e.g., the second mode 605 of FIG. 6A). For example, the wearable device 100 may additionally provide a gaze tracking function or a head tracking function using saved resources, by providing a pass-through function in the second mode (e.g., the second mode 605 of FIG. 6A). For example, the wearable device 100 may additionally execute a software application for the pass-through function and another software application using the saved resources, by providing the pass-through function in the second mode (e.g., the second mode 605 of FIG. 6A). For example, the wearable device 100 may provide the content 220 through the display assembly 308 using the saved resource. For example, the wearable device 100 may maintain the pass-through function while providing another function. For example, the wearable device 100 may enhance immersiveness of the user 120 by maintaining the pass-through function while providing another function. For example, the wearable device 100 may increase efficiency of an internal system of the wearable device 100 by maintaining the pass-through function while providing another function.

The at least one processor 307 may control the display assembly 308 to display, based on an event, a screen generated using an image obtained through the at least one first camera 309, within at least a portion of the display region or outside the display region. For example, the at least one processor 307 may render an image using depth values obtained with respect to obtaining an image through the at least one first camera 309. The screen on which the image is rendered is described and illustrated in more detail with reference to FIGS. 5A and 5B.

FIGS. 5A and 5B are diagrams illustrating examples of rendering an image according to various embodiments.

Referring to FIG. 5A, a screen 510 may be described as a screen, provided within at least a portion of a display region in which a gaze of a user 120 is located, in which an image is rendered using depth values. For example, displaying a screen in a manner corresponding to the screen 510 may be described as a first mode (e.g., the first mode 600 of FIG. 6A). For example, the first mode (e.g., the first mode 600 of FIG. 6A) may be referred to as a quality mode. For example, the at least one processor 307 may display the screen 510 within at least a portion of the display region based on an event for displaying the screen 510 within at least a portion of the display region in which the user's 120 gaze is located. For example, the at least one processor 307 may refrain from providing content other than a system user interface (system UI) while providing a pass-through function in the first mode. For example, the at least one processor 307 may provide the pass-through function and a function related to the system user interface, while providing the pass-through function in the first mode. For example, the at least one processor 307 may render an image using depth values obtained with respect to the image obtained through the at least one first camera 309. For example, the at least one processor 307 may render the image by applying depth values for each of a first visual object (e.g., the visual object 240) and a second visual object (e.g., the visual object 260) included in the image to each of the first visual object and the second visual object. For example, the at least one processor 307 may obtain depth values for each of visual objects (e.g., the visual object 240 to the visual object 280) included in the image while obtaining an image for the environment 130 through the at least one first camera 309. For example, the depth values may be used to perform depth re-projection. For example, the at least one processor 307 may cause the visual object included in the image to appear as seen through the eyes of the user 120, by performing the depth re-projection. For example, since a location of the at least one first camera 309 of the wearable device 100 and a location of the user's 120 eyes are different, it may be required to perform depth re-projection to provide the user 120 with the visual object through the display assembly 308. The depth re-projection is described and illustrated in more detail with reference to FIG. 5B.

Referring to FIG. 5B, a state 530 may be described as a state in which depth reprojection is performed using depth values on the screen 510. For example, the at least one processor 307 may obtain depth values (e.g., depth value 550-1, depth value 550-2, depth value 550-3, depth value 550-4, and/or depth value 550-5) while obtaining an image through the at least one first camera 309. For example, the depth value 550-1 may be described as a depth value for the visual object 240. For example, the depth value 550-2 may be described as a depth value for the visual object 250. For example, the depth value 550-3 may be described as a depth value for the visual object 260. For example, the depth value 550-4 may be described as a depth value for the visual object 270. For example, the depth value 550-5 may be described as a depth value for the visual object 280. For example, the at least one processor 307 may render an image using depth values. For example, the at least one processor 307 may render an image by applying each of depth values to each of the first visual object and the second visual object. For example, the at least one processor 307 may apply the depth value 550-1 to the visual object 240. For example, the at least one processor 307 may apply the depth value 550-2 to the visual object 250. For example, the at least one processor 307 may apply the depth value 550-3 to the visual object 260. For example, the at least one processor 307 may apply the depth value 550-4 to the visual object 270. For example, the at least one processor 307 may apply the depth value 550-5 to the visual object 280. For example, the at least one processor 307 may cause the visual object displayed on the screen 510 to appear as seen through the eyes of the user 120, by rendering the image using each of depth values corresponding to each of the visual objects.

Referring back to FIG. 5A, the screen 520 may be described as a screen, provided outside at least a portion of the display region in which the user's 120 gaze is located, in which an image is rendered using a portion of the depth values. For example, displaying a screen in a manner corresponding to the screen 520 may be described as a second mode (e.g., the second mode 605 of FIG. 6A). For example, the second mode (e.g., the second mode 605 of FIG. 6A) may be referred to as an efficiency mode. For example, the at least one processor 307 may display the screen 520 outside at least a portion of the display region, based on an event displaying the screen 520 outside at least a portion of the display region in which the user's 120 gaze is located. For example, the at least a portion of the display region may be described as a region in which the user's 120 gaze is located. For example, the at least one processor 307 may display a high-resolution image on the at least one portion while providing a pass-through function in a second mode (e.g., the second mode 605 of FIG. 6A). For example, the at least one processor 307 may display a relatively low-resolution image on a region different from the at least a portion, while providing the pass-through function in the second mode (e.g., the second mode 605 of FIG. 6A). For example, the at least one processor 307 may render the image using a portion of depth values obtained with respect to an image obtained through the at least one first camera 309. For example, the at least one processor 307 may render the image, by applying a depth value for a first visual object among depth values for each of a first visual object (e.g., the visual object 240) and a second visual object (e.g., the visual object 260) included in the image to each of the first visual object and the second visual object. For example, the at least one processor 307 may obtain depth values for each of visual objects (e.g., the visual object 240 to the visual object 280) included in the image, while obtaining the image for the environment 130 through the at least one first camera 309. For example, the at least one processor 307 may cause the visual object included in the image to appear as seen by the eyes of the user 120, by performing depth reprojection. For example, the at least one processor 307 may supply power to the at least one first camera 309 and the at least one second camera 310 while providing the screen 520 through the display assembly 308. For example, the at least one processor 307 may provide content 220 through the display assembly 308 while providing the screen 520 through the display assembly 308. For example, the at least one processor 307 may be required to control power to perform various functions. For example, the at least one processor 307 may be required to manage resources in order to perform various functions simultaneously. For example, the at least one processor 307 may change a method of performing depth re-projection to prevent and/or reduce waste of resources while providing a pass-through function. The method of performing the depth re-projection is described and illustrated in greater detail below with reference to FIG. 5B.

Referring back to FIG. 5B, a state 540 may be described as a state in which depth re-projection is performed using a portion of the depth values on the screen 520. For example, the at least one processor 307 may render an image by applying a portion of the depth values to each of the visual objects included in the image. For example, the at least one processor 307 may render an image by applying the depth value 550-1 for the visual object 240 to each of the visual object 240, the visual object 250, the visual object 260, the visual object 270, and the visual object 280. For example, the at least one processor 307 may consume power to apply each of the depth values to each of the visual objects. For example, the at least one processor 307 may reduce the amount of power consumed to render the image by applying the depth value 550-1 to each of the visual objects. For example, the at least one processor 307 may reduce the amount of power consumed to render the image and consume power to provide another function (e.g., gaze tracking function, head tracking function), by applying the depth value 550-1 to each of the visual objects. For example, when the at least one processor 307 performs depth re-projection using a portion of the depth values, another function may be further provided because the resources consumed to display the screen are decreased.

The at least one processor 307 may provide the screen 520 on which image processing has been weakly performed, by rendering an image using a portion of the depth values.

Referring back to FIG. 5A, the screen 520 may be described as a screen displayed according to rendering an image using a portion of depth values. For example, visual objects within the screen 520 may be described as visual objects on which depth re-projection has been performed using a portion of depth values. For example, since the at least one processor 307 performs depth re-projection using a portion of the depth values, visual objects within the screen 520 may be seen awkwardly. For example, as the at least one processor 307 applies a first depth value among the first depth value for the first visual object and a second depth value for the second visual object to the first visual object and the second visual object, visual objects within the screen 520 may not appear as seen by the user's eyes. For example, the visual object 240 within the screen 520 may appear as seen by the eyes of the user 120, by applying the depth value 550-1 to the visual object 240. For example, the visual object 270 within the screen 520 may not appear as seen by the eyes of the user 120, by applying the depth value 550-1 to the visual object 240.

The at least one processor 307 may control a method of performing depth re-projection to manage resources. For example, by adjusting a level of an image processing function or bypassing a portion of functional blocks in order to manage resources, the at least one processor 307 may control a scheme for performing depth re-projection. However, the disclosure is not limited thereto. For example, the at least one processor 307 may control a denoising function and/or a sharpening function to manage resources. For example, the at least one processor 307 may control the frames per second (FPS) of a sensor and/or a frequency of the sensor, in order to manage resources. For example, the at least one processor 307 may control a removal function of motion blur, in order to manage resources. For example, the at least one processor 307 may control a size of a region for a foveated rendering mode, in order to manage resources.

According to an embodiment, the at least one processor 307 may provide a denoising function using a denoising filter. For example, the denoising function may be described as a function of removing noise from an image. For example, the denoising function may include a blur function and a filtering function. For example, the blur function may be described as a function of readjusting a color value of a pixel for an image to a similar color value by comparing with a color value of each of pixels around the pixel. For example, the filtering function may be described as a function of removing a color value that is not necessary to display an image, by comparing a color value of a pixel for an image with color values for each of pixels around the pixel. For example, the at least one processor 307 may perform the denoising function more strongly or more frequently in a first mode (e.g., the first mode 600 of FIG. 6A) than in a second mode (e.g., the second mode 605 of FIG. 6A). For example, the at least one processor 307 may refrain from or bypass performing the denoising function in the second mode (e.g., the second mode 605 of FIG. 6A). For example, in order to manage resources, the at least one processor 307 may refrain from performing the denoising function in the second mode (e.g., the second mode 605 of FIG. 6A), or may perform it less frequently compared to the first mode (e.g., the first mode 600 of FIG. 6A). For example, a denoising filter for performing the denoising function in the first mode (e.g., the first mode 600 of FIG. 6A) may provide a stronger denoising function than another denoising filter for performing the denoising function in the second mode (e.g., the second mode 605 of FIG. 6A).

According to an embodiment, the at least one processor 307 may provide a sharpening function using a sharpening filter. For example, the sharpening function may be described as a function of enhancing sharpness of a screen by emphasizing a boundary between visual objects included in an image. For example, the at least one processor 307 may increase a contrast ratio of the boundary by performing the sharpening function. For example, the at least one processor 307 may cause each of the visual objects to be more easily distinguished by increasing the contrast ratio of the boundary. For example, the at least one processor 307 may maximize and/or increase a difference between a color value of a pixel included in the image and color values of each of neighboring pixels by performing the sharpening function. For example, the at least one processor 307 may perform the sharpening function more strongly or more frequently in the first mode (e.g., the first mode 600 of FIG. 6A) compared to the second mode (e.g., the second mode 605 of FIG. 6A). For example, in order to manage resources, the at least one processor 307 may refrain from performing the sharpening function in the second mode (e.g., the second mode 605 of FIG. 6A), or may perform it less frequently compared to the first mode (e.g., the first mode 600 of FIG. 6A). For example, a sharpening filter for performing the sharpening function in the first mode (e.g., the first mode 600 of FIG. 6A) may provide a stronger sharpening function than another sharpening filter for performing the sharpening function in the second mode (e.g., the second mode 605 of FIG. 6A). For example, the at least one processor 307 may display the screen 520 outside at least a portion of a display region, based on an event of displaying a screen outside at least a portion of the display region in which a gaze identified through the at least one second camera 310 is located, according to rendering the image using the other denoising filter that performs denoising less frequently than the denoising filter and the other sharpening filter that performs sharpening less frequently than the sharpening filter. The at least one processor 307 may perform sharpening and/or denoising. However, the disclosure is not limited thereto. For example, the at least one processor 307 may further perform a function different from sharpening to render an image. For example, the at least one processor 307 may further perform a function different from denoising to render an image.

The at least one processor 307 may control FPS of a camera (e.g., the at least one first camera 309 or the at least one second camera 310) in the first mode (e.g., the first mode 600 of FIG. 6A) to be higher than FPS of the camera in the second mode (e.g., the second mode 605 of FIG. 6A). For example, since power consumption increases as the FPS of the camera increases, the at least one processor 307 may control the FPS of the camera to manage resources. The at least one processor 307 may control a frequency of a sensor (not illustrated) in the first mode (e.g., the first mode 600 of FIG. 6A) to be higher than a frequency of the sensor in the second mode (e.g., the second mode 605 of FIG. 6A). For example, since power consumption increases as the frequency of the sensor increases, the at least one processor 307 may control the frequency of the sensor to manage resources. For example, the at least one processor 307 may obtain a more accurate depth value 550 as the frequency of the sensor increases. For example, the at least one processor 307 may obtain a depth value using a Time of Flight (ToF) technique through the sensor. For example, the ToF technique may include a direct Time of Flight (dToF) technique and an indirect Time of Flight (iToF) technique. For example, the ToF technique may be described as a technique for identifying a difference in wavelength and a difference in phase as the emitted light reaches an object and then the reflected light reaches the sensor. The dToF technique may be described as a technique for calculating a distance between the object and the sensor using a speed of light. The iToF technique may be described as a technique for calculating the distance between the object and the sensor by analyzing a phase difference of light.

The at least one processor 307 may perform motion blur removal weakly or less frequently in the second mode (e.g., the second mode 605 of FIG. 6A) than in the first mode (e.g., the first mode 600 of FIG. 6A). For example, motion blur may be described as an afterimage of a visual object included in a video frame being displayed on the display. For example, the at least one processor 307 may insert a black screen between video frames to remove motion blur. For example, the at least one processor 307 may perform weakly a function of removing motion blur in the second mode (e.g., the second mode 605 of FIG. 6A) than in the first mode (e.g., the first mode 600 of FIG. 6A) to manage resources.

According to an embodiment, based on an area ratio of the display assembly 308, the at least one processor 307 may perform image processing or change a mode. For example, based on determining that a ratio of screen displayed through the display assembly 308 and indicating a pass-through function is greater than a threshold ratio, the at least one processor 307 may change a mode from the second mode (e.g., the second mode 605 of FIG. 6A) to the first mode (e.g., the first mode 600 of FIG. 6A). For example, based on determining that a ratio of screen indicating a virtual object is less than a threshold ratio, the at least one processor 307 may change the mode from the second mode (e.g., the second mode 605 of FIG. 6A) to the first mode (e.g., the first mode 600 of FIG. 6A). For example, the at least one processor 307 may identify a ratio to an area in which an image indicating a pass-through and another image indicating a virtual object are displayed on the display assembly 308. For example, the at least one processor 307 may identify a type of screen displayed through the display assembly 308. For example, the at least one processor 307 may identify whether a screen displayed through the display assembly 308 is a screen indicating a pass-through function. For example, the at least one processor 307 may identify whether a screen displayed through the display assembly 308 is a screen indicating a virtual reality (VR) environment. For example, the at least one processor 307 may identify a ratio of a screen indicating the pass-through function displayed through the display assembly 308 to the display region of the display assembly 308. For example, the at least one processor 307 may identify a ratio of the screen indicating the VR environment displayed through the display assembly 308 to the display region of the display assembly 308. For example, the at least one processor 307 may (further) perform denoising and/or sharpening on the screen, based on determining that a ratio of a screen indicating the pass-through function to the display region of the display assembly 308 is greater than a threshold ratio (e.g., 40%).

The at least one processor 307 may have different times required to render an image according to a method of providing a screen. For example, the time required to render an image in the first mode (e.g., the first mode 600 of FIG. 6A) may be longer than the time required to render an image in the second mode (e.g., the second mode 605 of FIG. 6A). For example, since the at least one processor 307 performs more strongly or more frequently at least one of denoising function, sharpening function, and motion blur removal function than each of functions performed in the second mode (e.g., the second mode 605 of FIG. 6A) to render the image in the first mode (e.g., the first mode 600 of FIG. 6A), the time required to render an image in the first mode (e.g., the first mode 600 of FIG. 6A) may be longer than the time required to render an image in the second mode (e.g., the second mode 605 of FIG. 6A).

According to an embodiment, the at least one processor 307 may change a mode for rendering an image based on a user input. For example, the user input may include receiving through an input device. For example, the user input may include detecting a gaze of the user 120. For example, the user input may include detecting a gaze of the user 120 toward an executable object (not illustrated) with respect to a change in mode. For example, the wearable device 100 may include an input device (not illustrated). For example, the wearable device 100 may receive a user input through the input device. For example, the wearable device 100 may change a mode for rendering an image from a first mode (e.g., the first mode 600 of FIG. 6A) to a second mode (e.g., the second mode 605 of FIG. 6A), based on a user input received through the input device. For example, the wearable device 100 may change a mode for rendering an image from a second mode (e.g., the second mode 605 of FIG. 6A) to a first mode (e.g., the first mode 600 of FIG. 6A) based on a user input received through the input device. However, the disclosure is not limited thereto. For example, the wearable device 100 may change the mode for rendering an image, based on detecting the user's 120 gaze on an executable object (not illustrated) displayed through the display assembly 308. For example, the wearable device 100 may provide a screen 510 through the display assembly 308 according to rendering an image using depth values obtained with respect to obtaining the image, before receiving the user input. For example, the wearable device 100 may provide a screen 520 through the display assembly 308, according to rendering an image using a portion of the depth values obtained with respect to obtaining the image based on the reception of the user input.

The at least one processor 307 may provide a passthrough function in a first mode (e.g., the first mode 600 of FIG. 6A) or a second mode (e.g., the second mode 605 of FIG. 6A), based on a state of the user 120. The description of the first mode and the second mode is described in greater detail below and illustrated with reference to FIG. 6A.

FIG. 6A is a diagram illustrating an example of describing features for each mode according to various embodiments.

Referring to FIG. 6A, at least one processor 307 may provide a user 120 with a pass-through function operating in a first mode 600 or a second mode 605. For example, the at least one processor 307 may identify whether the user 120 is focused on content 220. For example, the at least one processor 307 may execute a pass-through function in the second mode 605, based on identifying that the user 120 is focused on the content 220. For example, the at least one processor 307 may provide a pass-through function in the first mode 600 based on identifying that the user 120 is not focused on the content 220. For example, the first mode 600 and the second mode 605 may operate according to priorities for image processing techniques.

The first mode 600 may be referred to as a quality mode. For example, the at least one processor 307 may operate in the first mode 600 with a high priority for peripheral comfort, full-view comfort, distortion and ghosting reduction, and image quality. For example, the at least one processor 307 may operate in the second mode 605 with a low priority for performance. For example, the peripheral comfort and the full-view comfort may be referred to as re-projection for depth values described in FIGS. 5A and 5B. For example, the peripheral comfort may be described in a manner in which depth value correction is applied to a peripheral portion of a screen displayed through the display assembly 308. For example, the peripheral portion may include a region different from a region in which the content 220 is displayed. For example, the full-view comfort may be described in a manner in which depth value correction is applied to the entire screen displayed through the display assembly 308. A function for distortion and ghosting reduction may include a function for reducing spatial distortion. For example, the function for distortion and ghosting reduction may be operated by performing interpolation on an image obtained through the at least one first camera 309. The image quality may include a description of denoising, sharpening, and/or motion blur described through FIG. 5A. For example, the performance may include performance for all functions provided by the wearable device 100. For example, the performance may include performance for a function different from a pass-through function. For example, the performance for a pass-through in the first mode 600 may be greater than the performance for a pass-through in the second mode 605. For example, the performance for playing the content 220 in the first mode 600 may be worse than the performance for playing the content 220 in the second mode 605.

The second mode 605 may be referred to as an efficiency mode. For example, the at least one processor 307 may operate in the second mode 605 with a high priority for peripheral comfort, distortion and ghosting reduction, and performance. For example, the at least one processor 307 may operate in the second mode 605 with a low priority for full-view comfort and image quality.

TABLE 1

| | First mode | Second mode |
|---|---|---|
| | (quality mode) | (efficiency mode) |
| VST Camera | 90fps | 90fps |
| iToF speed | Less than 2-5fps | Less than 2fps |
| and dToF speed | | |
| VST | Fovea: less than or equal | Fovea is much smaller than |
| Resolution | to 1500 × 1500 | 1500 × 1500 |
| | Peripheral portion: | VST resolution is less than |
| | 1500 × 1500 | or equal to 1500 × 1500 |
| P2P and M2P | P2P is less than or equal | P2P is less than or equal |
| | to 20-25 m, | to 20-25 ms, |
| | M2P is less than or equal | M2P is less than or equal |
| | to 20 ms | to 20 ms |
| Image quality | Less than 5 ms | Less than 2 ms |
| (IQ) GPU | | |
| budget | | |

The performance of the first mode 600 and the second mode 605 will be described with reference to Table 1. For example, point-to-point (P2P) may be described as a direct data transmission method between two points. For example, memory-to-processor (M2P) may be described as a method of transmitting data from memory to a processor. For example, the first mode 600 may be operated with a higher resolution than the second mode 605. The at least one processor 307 may provide a pass-through function in the first mode 600 or the second mode 605. For example, the at least one processor 307 may switch a mode in which a pass-through function is provided from the first mode 600 to the second mode 605 based on a user input. For example, the at least one processor 307 may switch a mode in which a pass-through function is provided from the second mode 605 to the first mode 600 based on a state of the user 120.

TABLE 2

| Initial state | Action | Later state |
|---|---|---|
| Wearable device is | Turn on wearable device | First mode or Second |
| in off-state | | mode on home screen |
| Home screen in | Providing double tap to | First mode |
| second mode | wearable device | |
| First mode | Providing double tap to | Return to previous |
| | wearable device | state |
| First mode | Recenter | Return to home screen |
| | | in second mode |
| First mode | Home screen open | Return to home screen |
| | | in second mode |
| Home screen in | Going out of guardian | First mode |
| second mode | region | |
| first mode outside | Coming into guardian | Return to previous |
| guardian region | region | state |
| Home screen in VR | Providing swipe to | Home screen in second |
| | wearable device | mode |
| Home screen in | Providing input to pass- | Home screen in VR |
| second mode | through input device | |
| Home screen in | Providing swipe to | Home screen in VR |
| second mode | wearable device | |
| First mode | Providing swipe to | No response |
| | wearable device | |
| Executing software | Providing swipe to | No response |
| application for VR | wearable device | |
| Executing software | Providing double tap to | First mode |
| application for VR | wearable device | |
| Executing software | Going out of guardian | First mode |
| application for VR | region | |

Referring to Table 2, switching from the first mode 600 to the second mode 605 or switching from the second mode 605 to the first mode 600 according to the action of the user 120 is described. For example, the initial state of Table 2 may be described as a state before an action. For example, the later state of Table 2 may be described as a state after an action. For example, the action may include an input or an action provided by the user 120 while in the initial state. For example, the wearable device 100 may switch from the initial state to the later state based on identifying the action. The at least one processor 307 may provide a screen in the first mode or the second mode 605 based on identification of an event, via the display assembly 308. For example, the at least one processor 307 may provide a screen in the first mode, by approaching a boundary of a recommended region (e.g., the recommended region 610) in which the activities of the wearable device 100 are recommended. For example, the recommended region is described and illustrated in more detail with reference to FIG. 6B.

FIG. 6B is a diagram illustrating an example of an event related to a recommended region according to various embodiments.

Referring to FIG. 6B, the at least one processor 307 may identify whether the wearable device 100 is within the recommended region 610. For example, the at least one processor 307 may identify the recommended region 610 using an image obtained through the at least one first camera 309. For example, the at least one processor 307 may identify whether the wearable device 100 is within the recommended region 610 using the image. For example, the recommended region 610 may be described as a region in which movement of the user 120 is recommended for the safety of the user 120. For example, the recommended region 610 may be referred to as a guardian region. For example, the recommended region 610 may be set in a form of a circle centered on the user 120. However, the disclosure is not limited thereto. For example, the recommended region 610 may be set in various forms (e.g., polygon) in consideration of the environment 130 in which the user 120 is included. For example, the at least one processor 307 may provide a screen in the first mode 600 or the second mode 605 based on an event, through the display assembly 308 including a display region. For example, the event may include the wearable device 100 approaching a boundary of the recommended region 610 recommended for the movement of the user 120 by the user 120 of the wearable device 100. For example, when the user 120 approaches the boundary of the recommended region 610, the at least one processor 307 may be required to provide a pass-through function to prevent and/or reduce an accident of the user 120. For example, the at least one processor 307 may measure or determine a distance between the wearable device 100 and a boundary of the recommended region 610 using an image obtained through the at least one first camera 309. For example, the at least one processor 307 may determine that the user 120 is interested in the environment 130 by identifying that the user 120 is located at the boundary of the recommended region 610. For example, the at least one processor 307 may provide a pass-through function in the first mode 600 among the first mode 600 and the second mode 605, while identifying that the user 120 is located at the boundary of the recommended region 610. For example, the at least one processor 307 may display the screen in the first mode 600, based on determining that a distance between the boundary of the recommended region 610 and the wearable device 100 is less than a threshold distance. For example, the at least one processor 307 may display the screen 510, within at least a portion of the display region, based on an event in which a distance between the user 120 and the boundary of the recommended region 610 is less than a threshold distance, according to rendering the image using depth values obtained with respect to obtaining the image. For example, the at least one processor 307 may display a screen within at least a portion of the display region in which the user's 120 gaze identified through the at least one second camera 310 is located, and display the screen 510 within at least a portion of the display region, based on an event in which a distance between the user 120 of the wearable device 100 and a boundary of the recommended region 610 recommended for the movement of the user 120 is less than a threshold distance, according to rendering the image using depth values obtained with respect to obtaining the image. For example, the at least one processor 307 may identify whether the user 120 is located within the recommended region 610. For example, the at least one processor 307 may provide a passthrough function in the first mode 600 or the second mode 605, based on identifying whether the user 120 is located within the recommended region 610. For example, the at least one processor 307 may identify whether the user 120 is located within the recommended region 610, using images obtained through the at least one first camera 309. For example, the at least one processor 307 may provide a pass-through function in the first mode 600 based on determining that the user 120 is outside the recommended region 610. For example, the at least one processor 307 may provide a pass-through function in the second mode 605 based on determining that the user 120 is within the recommended region 610.

For example, the at least one processor 307 may perform alpha blending based on identifying that the wearable device 100 is located at the boundary of the recommended region 610. For example, the alpha blending may be described as a technique of blending images by controlling transparencies of different images displayed through the display assembly 308. For example, the at least one processor 307 may perform alpha blending on an image indicating a pass-through and another image indicating a virtual screen, based on the determination that the wearable device 100 is located at the boundary of the recommended region 610. For example, performing alpha blending on the image indicating a pass-through and the other image indicating a virtual screen may consume a lot of power. For example, the at least one processor 307 may lower the resolution of the image indicating a pass-through, in order to reduce the power consumed to perform alpha blending. For example, the at least one processor 307 may deactivate image processing for the image indicating a passthrough or reduce the intensity of image processing, in order to reduce the power consumed to perform alpha blending. For example, the image processing may include at least one of a denoising function, a sharpening function, and a motion blur removal function. For example, the at least one processor 307 may change a mode of the wearable device 100 from the second mode 605 to the first mode 600, based on the determination that the wearable device 100 is located at the boundary of the recommended region 610.

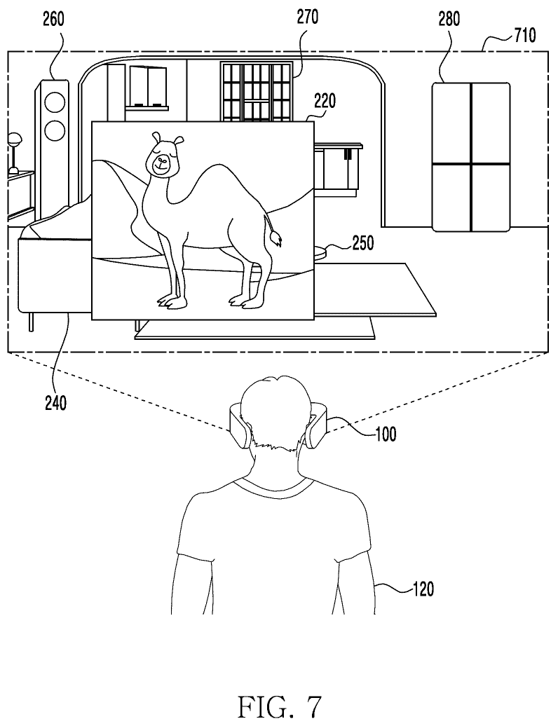

For example, the at least one processor 307 may provide content 220 through the display assembly 308. For example, the at least one processor 307 may identify a location of the user's 120 gaze through the at least one second camera 310. For example, the at least one processor 307 may detect the gaze of the user 120 toward the content 220 through the at least one second camera 310. For example, the at least one processor 307 may display a screen in the second mode 605, based on the user's gaze being located outside at least a portion of the display region at which the user's 120 gaze is located for a preset time, while the content 220 is provided outside the at least a portion of the display region. The detection of the gaze with respect to the content is described and illustrated in greater detail below with reference to FIG. 7.

FIG. 7 is a diagram illustrating an example of an event related to content according to various embodiments.

Referring to FIG. 7, a state 710 may be described as a state in which visual objects corresponding to the content 220 and the environment 130 are displayed through the display assembly 308. The at least one processor 307 may display the screen 510 in at least a portion of the display region, based on an event displaying a screen within at least a portion of the display region while the content 220 is displayed within at least a portion of the display region in which the gaze identified through the at least one second camera 310 is located, according to rendering the image using depth values (e.g., depth value 550-1 to depth value 550-5). The at least one processor 307 may display the screen 520 outside at least a portion of the display region, based on an event displaying a screen outside at least a portion of the display region while the content 220 is displayed outside at least a portion of the display region in which the gaze identified through the at least one second camera 310 is located, according to rendering the image using a portion (e.g., depth value 550-1) of depth values (e.g., depth value 550-1 to depth value 550-5). For example, the at least one processor 307 may identify a location of the user's 120 gaze using an image obtained through the at least one second camera 310. For example, the at least one processor 307 may detect the gaze of the user 120 through the at least one second camera 310. For example, the at least one processor 307 may identify at least a portion of the display region included in the display assembly 308 to which the user's 120 gaze is located, through at least one second camera 310. For example, at least a portion of the display region may be described as a region at which the user's 120 gaze is located. For example, the user 120 may gaze at the content 220 or another screen while the content 220 is provided through the display assembly 308. For example, the at least one processor 307 may determine that the user 120 is interested in the content 220 based on receiving a user input for playing the content 220. For example, the at least one processor 307 may provide a pass-through function in the second mode 605, based on the determination that the user 120 is interested in the content 220. For example, the at least one processor 307 may display the screen 520 outside at least a portion of the display region, based on the determination that the user 120 is interested in the content 220, according to rendering an image using a portion of depth values.

However, the disclosure is not limited thereto. For example, the at least one processor 307 may detect a gaze toward another region different from the region in which the content 220 is played, while the content 220 is provided through the display assembly 308. For example, the at least one processor 307 may detect a gaze of the user 120 toward one of the visual object 240, the visual object 250, the visual object 260, the visual object 270, and the visual object 280, while the content 220 is provided through the display assembly 308. For example, the at least one processor 307 may determine that the user 120 is interested in the environment 130 based on detecting the gaze toward the other region. For example, the at least one processor 307 may provide a pass-through function in the first mode 600, based on the determination that the user 120 is interested in the environment. For example, the at least one processor 307 may display the screen 510 within at least a portion of the display region, according to rendering the image using depth values.

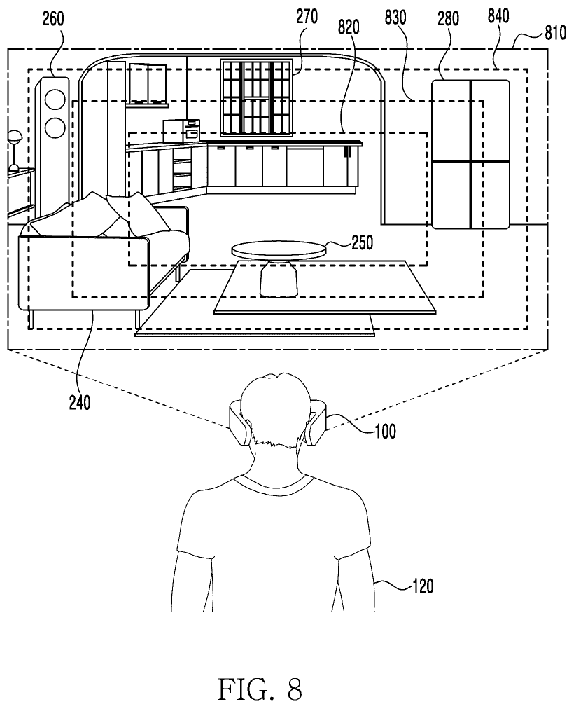

The at least one processor 307 may provide a foveated rendering mode while providing a pass-through function. For example, the at least one processor 307 may differently control a region of the foveated rendering mode, according to the first mode 600 or the second mode 605. The foveated rendering mode is described and illustrated in greater detail below with reference to FIG. 8.

FIG. 8 is a diagram illustrating an example of controlling a size of a region related to a foveated rendering mode according to various embodiments.

Referring to FIG. 8, a state 810 may be described as a state in which a high-resolution region of the foveated rendering mode varies according to the first mode 600 or the second mode 605. For example, the foveated rendering mode may be described as a mode providing screens with different resolutions by distinguishing the display region of the display assembly 308. For example, while the foveated rendering mode is being executed, the at least one processor 307 may determine a central portion of the display region as a high-resolution region, and a peripheral portion of the display region as a low-resolution region. For example, the at least one processor 307 may display an image processed with a high resolution within the high-resolution region of the display region. For example, the at least one processor 307 may display an image processed with a low resolution within the low-resolution region of the display region. For example, the at least one processor 307 may reduce power consumed to provide an image by distinguishing the high-resolution region from the low-resolution region. For example, the at least one processor 307 may manage resources, by distinguishing the high-resolution region from the low-resolution region.

The at least one processor 307 may differently determine sizes of the high-resolution region and the low-resolution region of the foveated rendering mode, according to the first mode 600 or the second mode 605. For example, the at least one processor 307 may display the screen 510 within at least a portion of the display region, based on an event of displaying a screen within at least a portion of the display region in which the gaze of the user 120 identified through at least one second camera 310 is located, according to rendering the image using depth values obtained with respect to obtaining the image. For example, the first mode 600 may be described as rendering an image using depth values obtained with respect to obtaining the image. For example, the at least one processor 307 may display the screen 520 outside at least a portion of the display region, based on an event of displaying a screen outside at least a portion of the display region in which the gaze identified through the at least one second camera 310 is located, according to rendering the image using a portion of the depth values. For example, the second mode 605 may be described as rendering an image using a portion (e.g., depth value 550-1) of depth values obtained with respect to obtaining the image. For example, the power consumed by the wearable device 100 while applying the first mode 600 may be greater than the power consumed by the wearable device 100 while applying the second mode 605. For example, since the first mode 600 targets to provide a high-quality image or screen to the user 120, the at least one processor 307 may provide a large size of the high-resolution region while the foveated rendering mode is provided in the first mode 600.

For example, the at least one processor 307 may determine a region 820 as the high-resolution region of the foveated rendering mode while the second mode 605 is applied. For example, the at least one processor 307 may provide a high-quality image or screen in the region 820 and a low-quality image or screen in a region (e.g., region 830 to region 840) except for the region 820, based on the region 820 being determined to the high-resolution region.

For example, the at least one processor 307 may determine a region 830 as the high-resolution region of the foveated rendering mode while the first mode 600 is applied. For example, the at least one processor 307 may provide a high-quality image or screen in the region 830, and a low-quality image or screen in a region (e.g., region 840) except for the region 830, based on the region 830 being determined to the high-resolution region. For example, a size of the high-resolution region in the first mode 600 may be larger than a size of the high-resolution region in the second mode 605 such that the at least one processor 307 may provide a high-quality image or screen to the user 120 in the first mode 600. For example, the high-resolution region of the foveated rendering mode in the first mode 600 may be the region 830. For example, the high-resolution region of the foveated rendering mode in the second mode 605 may be the region 820.

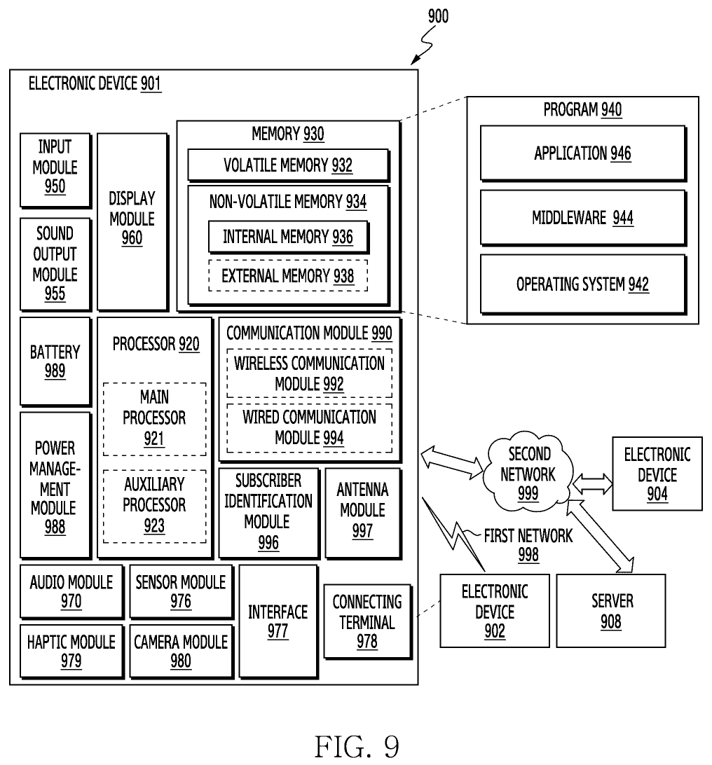

FIG. 9 is a block diagram illustrating an example electronic device 901 in a network environment 900 according to various embodiments.

Referring to FIG. 9, the electronic device 901 in the network environment 900 may communicate with an electronic device 902 via a first network 998 (e.g., a short-range wireless communication network), or at least one of an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input module 950, a sound output module 955, a display module 960, an audio module 970, a sensor module 976, an interface 977, a connecting terminal 978, a haptic module 979, a camera module 980, a power management module 988, a battery 989, a communication module 990, a subscriber identification module (SIM) 996, or an antenna module 997. In various embodiments, at least one of the components (e.g., the connecting terminal 978) may be omitted from the electronic device 901, or one or more other components may be added in the electronic device 901. In various embodiments, some of the components (e.g., the sensor module 976, the camera module 980, or the antenna module 997) may be implemented as a single component (e.g., the display module 960).

The processor 920 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 920 may execute, for example, software (e.g., a program 940) to control at least one other component (e.g., a hardware or software component) of the electronic device 901 coupled with the processor 920, and may perform various data processing or computation. According to an embodiment, as at least part of the data processing or computation, the processor 920 may store a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), or an auxiliary processor 923 (e.g., a graphics processing unit (GPU), a neural processing unit (NPU), an image signal processor (ISP), a sensor hub processor, or a communication processor (CP)) that is operable independently from, or in conjunction with, the main processor 921. For example, when the electronic device 901 includes the main processor 921 and the auxiliary processor 923, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display module 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923. According to an embodiment, the auxiliary processor 923 (e.g., the neural processing unit) may include a hardware structure specified for artificial intelligence model processing. An artificial intelligence model may be generated by machine learning. Such learning may be performed, e.g., by the electronic device 901 where the artificial intelligence is performed or via a separate server (e.g., the server 908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input module 950 may receive a command or data to be used by another component (e.g., the processor 920) of the electronic device 901, from the outside (e.g., a user) of the electronic device 901. The input module 950 may include, for example, a microphone, a mouse, a keyboard, a key (e.g., a button), or a digital pen (e.g., a stylus pen).

The sound output module 955 may output sound signals to the outside of the electronic device 901. The sound output module 955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 960 may visually provide information to the outside (e.g., a user) of the electronic device 901. The display module 960 may include, for example, a display, a hologram device, or a projector and control circuitry to control a corresponding one of the display, hologram device, and projector. According to an embodiment, the display module 960 may include a touch sensor adapted to detect a touch, or a pressure sensor adapted to measure the intensity of force incurred by the touch.

The audio module 970 may convert a sound into an electrical signal and vice versa. According to an embodiment, the audio module 970 may obtain the sound via the input module 950, or output the sound via the sound output module 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, an HDMI connector, a USB connector, a SD card connector, or an audio connector (e.g., a headphone connector).

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to an embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The wireless communication module 992 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 992 may support a high-frequency band (e.g., the mmWave band) to achieve, e.g., a high data transmission rate. The wireless communication module 992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 992 may support various requirements specified in the electronic device 901, an external electronic device (e.g., the electronic device 904), or a network system (e.g., the second network 999). According to an embodiment, the wireless communication module 992 may support a peak data rate (e.g., 20 Gbps or more) for implementing eMBB, loss coverage (e.g., 964 dB or less) for implementing mMTC, or U-plane latency (e.g., 0.5 ms or less for each of downlink (DL) and uplink (UL), or a round trip of 9 ms or less) for implementing URLLC.

The antenna module 997 may transmit or receive a signal or power to or from the outside (e.g., the external electronic device) of the electronic device 901. According to an embodiment, the antenna module 997 may include an antenna including a radiating element including a conductive material or a conductive pattern formed in or on a substrate (e.g., a printed circuit board (PCB)). According to an embodiment, the antenna module 997 may include a plurality of antennas (e.g., array antennas). In such a case, at least one antenna appropriate for a communication scheme used in the communication network, such as the first network 998 or the second network 999, may be selected, for example, by the communication module 990 (e.g., the wireless communication module 992) from the plurality of antennas. The signal or the power may then be transmitted or received between the communication module 990 and the external electronic device via the selected at least one antenna. According to an embodiment, another component (e.g., a radio frequency integrated circuit (RFIC)) other than the radiating element may be additionally formed as part of the antenna module 997.

According to various embodiments, the antenna module 997 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 or 904 may be a device of a same type as, or a different type, from the electronic device 901. According to an embodiment, all or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, mobile edge computing (MEC), or client-server computing technology may be used, for example. The electronic device 901 may provide ultra low-latency services using, e.g., distributed computing or mobile edge computing. In an embodiment, the external electronic device 904 may include an internet-of-things (IoT) device. The server 908 may be an intelligent server using machine learning and/or a neural network. According to an embodiment, the external electronic device 904 or the server 908 may be included in the second network 999. The electronic device 901 may be applied to intelligent services (e.g., smart home, smart city, smart car, or healthcare) based on 5G communication technology or IoT-related technology.

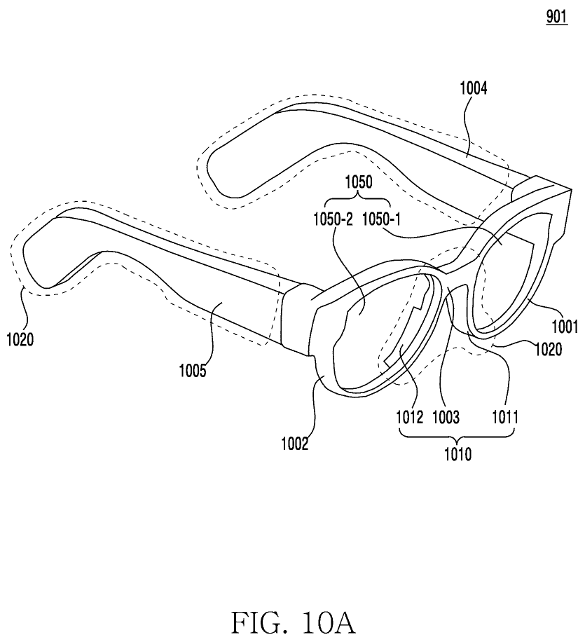

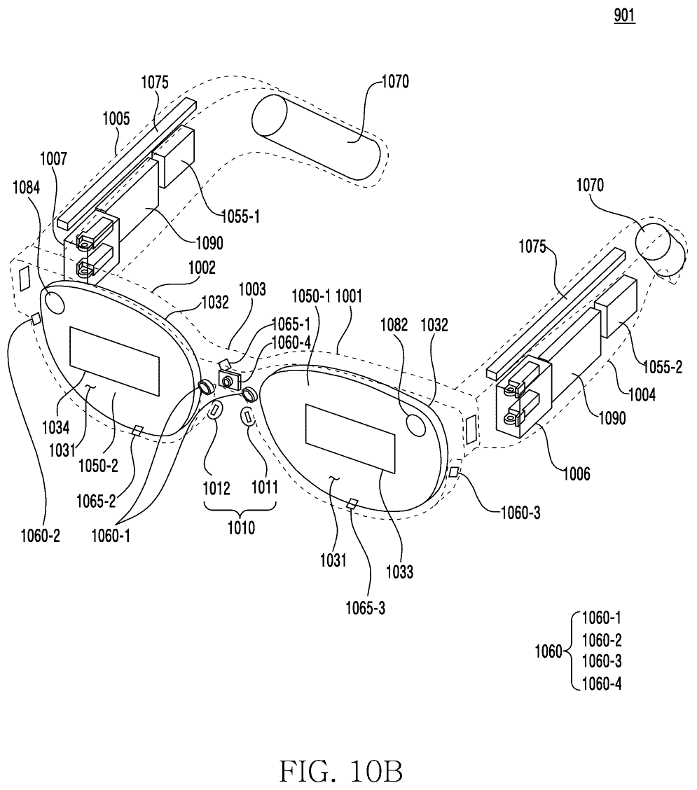

FIG. 10A is a perspective view illustrating an example wearable device according to various embodiments.

FIG. 10B is a perspective view illustrating one or more hardware disposed in a wearable device according to various embodiments.

According to an embodiment, a wearable device 100 (e.g., the electronic device 901) may have a shape of glasses wearable on a user's body part (e.g., head). The electronic device 901 of FIGS. 10A to 10B may be an example of the wearable device 100 of FIG. 1. The wearable device 100 may include a head-mounted display (HMD). For example, a housing of the wearable device 100 may include flexible materials, such as rubber and/or silicone, that are in close contact with a part (e.g., a part of the face that covers both eyes) of the user's head. For example, a housing of the wearable device 100 may include one or more straps able to be twined around the user's head and/or one or more temples attachable to the head's ear.

Referring to FIG. 10A, according to an embodiment, the wearable device 100 may include at least one display 1050 and a frame 1000 supporting the at least one display 1050.

According to an embodiment, the wearable device 100 may be wearable on a portion of the user's body. The wearable device 100 may provide augmented reality (AR), virtual reality (VR), or mixed reality (MR) combining the augmented reality and the virtual reality to a user wearing the wearable device 100. For example, the wearable device 100 may display a virtual reality image provided from at least one optical device 1082 and 1084 of FIG. 10B on at least one display 1050, in response to a user's preset gesture obtained through a motion recognition camera 1060-2 and 1060-3 of FIG. 10B.

According to an embodiment, the at least one display 1050 may provide visual information to a user. For example, the at least one display 1050 may include a transparent or translucent lens. The at least one display 1050 may include a first display 1050-1 and/or a second display 1050-2 spaced apart from the first display 1050-1. For example, the first display 1050-1 and the second display 1050-2 may be disposed at positions corresponding to the user's left and right eyes, respectively.

Referring to FIG. 10B, the at least one display 1050 may provide visual information transmitted through a lens included in the at least one display 1050 from ambient light to a user and other visual information distinguished from the visual information. The lens may be formed based on at least one of a fresnel lens, a pancake lens, or a multi-channel lens. For example, the at least one display 1050 may include a first surface 1031 and a second surface 1032 opposite to the first surface 1031. A display area may be formed on the second surface 1032 of at least one display 1050. When the user wears the wearable device 100, ambient light may be transmitted to the user by being incident on the first surface 1031 and being penetrated through the second surface 1032. For another example, the at least one display 1050 may display an augmented reality image in which a virtual reality image provided by the at least one optical device 1082 and 1084 is combined with a reality screen transmitted through ambient light, on a display area formed on the second surface 1032.

In an embodiment, the at least one display 1050 may include at least one waveguide 1033 and 1034 that transmits light transmitted from the at least one optical device 1082 and 1084 by diffracting to the user. The at least one waveguide 1033 and 1034 may be formed based on at least one of glass, plastic, or polymer. A nano pattern may be formed on at least a portion of the outside or inside of the at least one waveguide 1033 and 1034. The nano pattern may be formed based on a grating structure having a polygonal or curved shape. Light incident to an end of the at least one waveguide 1033 and 1034 may be propagated to another end of the at least one waveguide 1033 and 1034 by the nano pattern. The at least one waveguide 1033 and 1034 may include at least one of at least one diffraction element (e.g., a diffractive optical element (DOE), a holographic optical element (HOE)), and a reflection element (e.g., a reflection mirror). For example, the at least one waveguide 1033 and 1034 may be disposed in the wearable device 100 to guide a screen displayed by the at least one display 1050 to the user's eyes. For example, the screen may be transmitted to the user's eyes based on total internal reflection (TIR) generated in the at least one waveguide 1033 and 1034.

The wearable device 100 may analyze an object included in a real image collected through a photographing camera 1060-4, combine with a virtual object corresponding to an object that become a subject of augmented reality provision among the analyzed object, and display on the at least one display 1050. The virtual object may include at least one of text and images for various information associated with the object included in the real image. The wearable device 100 may analyze the object based on a multi-camera such as a stereo camera. For the object analysis, the wearable device 100 may execute space recognition (e.g., simultaneous localization and mapping (SLAM)) using the multi-camera and/or time-of-flight (ToF). The user wearing the wearable device 100 may watch an image displayed on the at least one display 1050.

According to an embodiment, a frame 1000 may be configured with a physical structure in which the wearable device 100 may be worn on the user's body. According to an embodiment, the frame 1000 may be configured so that when the user wears the wearable device 100, the first display 1050-1 and the second display 1050-2 may be positioned corresponding to the user's left and right eyes. The frame 1000 may support the at least one display 1050. For example, the frame 1000 may support the first display 1050-1 and the second display 1050-2 to be positioned at positions corresponding to the user's left and right eyes.

Referring to FIG. 10A, according to an embodiment, the frame 1000 may include an area 1020 at least partially in contact with the portion of the user's body in case that the user wears the wearable device 100. For example, the area 1020 of the frame 1000 in contact with the portion of the user's body may include an area in contact with a portion of the user's nose, a portion of the user's ear, and a portion of the side of the user's face that the wearable device 100 contacts. According to an embodiment, the frame 1000 may include a nose pad 1010 that is contacted on the portion of the user's body. When the wearable device 100 is worn by the user, the nose pad 1010 may be contacted on the portion of the user's nose. The frame 1000 may include a first temple 1004 and a second temple 1005, which are contacted on another portion of the user's body that is distinct from the portion of the user's body.

For example, the frame 1000 may include a first rim 1001 surrounding at least a portion of the first display 1050-1, a second rim 1002 surrounding at least a portion of the second display 1050-2, a bridge 1003 disposed between the first rim 1001 and the second rim 1002, a first pad 1011 disposed along a portion of the edge of the first rim 1001 from one end of the bridge 1003, a second pad 1012 disposed along a portion of the edge of the second rim 1002 from the other end of the bridge 1003, the first temple 1004 extending from the first rim 1001 and fixed to a portion of the wearer's ear, and the second temple 1005 extending from the second rim 1002 and fixed to a portion of the ear opposite to the ear. The first pad 1011 and the second pad 1012 may be in contact with the portion of the user's nose, and the first temple 1004 and the second temple 1005 may be in contact with a portion of the user's face and the portion of the user's ear. The temples 1004 and 1005 may be rotatably connected to the rim through hinge units 1006 and 1007 of FIG. 10B. The first temple 1004 may be rotatably connected with respect to the first rim 1001 through the first hinge unit 1006 disposed between the first rim 1001 and the first temple 1004. The second temple 1005 may be rotatably connected with respect to the second rim 1002 through the second hinge unit 1007 disposed between the second rim 1002 and the second temple 1005. According to an embodiment, the wearable device 100 may identify an external object (e.g., a user's fingertip) touching the frame 1000 and/or a gesture performed by the external object using a touch sensor, a grip sensor, and/or a proximity sensor formed on at least a portion of the surface of the frame 1000.

According to an embodiment, the wearable device 100 may include hardware (e.g., hardware described above based on the block diagram of FIG. 4) that performs various functions. For example, the hardware may include a battery module 1070, an antenna module 1075, the at least one optical device 1082 and 1084, speakers (e.g., speakers 1055-1 and 1055-2), a microphone (e.g., microphones 1065-1, 1065-2, and 1065-3), a light emitting module (not illustrated), and/or a printed circuit board (PCB) (e.g., printed circuit board 1090). Various hardware may be disposed in the frame 1000.

According to an embodiment, the microphone (e.g., the microphones 1065-1, 1065-2, and 1065-3) of the wearable device 100 may obtain a sound signal, by being disposed on at least a portion of the frame 1000. The first microphone 1065-1 disposed on the bridge 1003, the second microphone 1065-2 disposed on the second rim 1002, and the third microphone 1065-3 disposed on the first rim 1001 are illustrated in FIG. 10B, but the number and disposition of the microphone 1065 are not limited to an embodiment of FIG. 10B. In case that the number of the microphone 1065 included in the wearable device 100 is two or more, the wearable device 100 may identify a direction of the sound signal using a plurality of microphones disposed on different portions of the frame 1000.

According to an embodiment, the at least one optical device 1082 and 1084 may project a virtual object on the at least one display 1050 in order to provide various image information to the user. For example, the at least one optical device 1082 and 1084 may be a projector. The at least one optical device 1082 and 1084 may be disposed adjacent to the at least one display 1050 or may be included in the at least one display 1050 as a portion of the at least one display 1050. According to an embodiment, the wearable device 100 may include a first optical device 1082 corresponding to the first display 1050-1, and a second optical device 1084 corresponding to the second display 1050-2. For example, the at least one optical device 1082 and 1084 may include the first optical device 1082 disposed at a periphery of the first display 1050-1 and the second optical device 1084 disposed at a periphery of the second display 1050-2. The first optical device 1082 may transmit light to the first waveguide 1033 disposed on the first display 1050-1, and the second optical device 1084 may transmit light to the second waveguide 1034 disposed on the second display 1050-2.

In an embodiment, a camera 1060 may include the photographing camera 1060-4, an eye tracking camera (ET CAM) 1060-1, and/or the motion recognition camera 1060-2 and 1060-3. The photographing camera 1060-4, the eye tracking camera 1060-1, and the motion recognition camera 1060-2 and 1060-3 may be disposed at different positions on the frame 1000 and may perform different functions. The eye tracking camera 1060-1 may output data indicating a position of eye or a gaze of the user wearing the wearable device 100. For example, the wearable device 100 may detect the gaze from an image including the user's pupil obtained through the eye tracking camera 1060-1. The wearable device 100 may identify an object (e.g., a real object, and/or a virtual object) focused by the user, using the user's gaze obtained through the eye tracking camera 1060-1. The wearable device 100 identifying the focused object may execute a function (e.g., gaze interaction) for interaction between the user and the focused object. The wearable device 100 may represent a portion corresponding to eye of an avatar indicating the user in the virtual space, using the user's gaze obtained through the eye tracking camera 1060-1. The wearable device 100 may render an image (or a screen) displayed on the at least one display 1050, based on the position of the user's eye. For example, visual quality (e.g., resolution, brightness, saturation, grayscale, and PPI) of a first area related to the gaze within the image and visual quality of a second area distinguished from the first area may be different. The wearable device 100 may obtain an image having the visual quality of the first area matching the user's gaze and the visual quality of the second area using foveated rendering. For example, when the wearable device 100 supports an iris recognition function, user authentication may be performed based on iris information obtained using the eye tracking camera 1060-1. An example in which the eye tracking camera 1060-1 is disposed toward the user's right eye is illustrated in FIG. 10B, but the disclosure is not limited thereto, and the eye tracking camera 1060-1 may be disposed alone toward the user's left eye or may be disposed toward two eyes.

In an embodiment, the photographing camera 1060-4 may photograph a real image or background to be matched with a virtual image in order to implement the augmented reality or mixed reality content. The photographing camera 1060-4 may be used to obtain an image having a high resolution based on a high resolution (HR) or a photo video (PV). The photographing camera 1060-4 may photograph an image of a specific object existing at a position viewed by the user and may provide the image to the at least one display 1050. The at least one display 1050 may display one image in which a virtual image provided through the at least one optical device 1082 and 1084 is overlapped with information on the real image or background including an image of the specific object obtained using the photographing camera 1060-4. The wearable device 100 may compensate for depth information (e.g., a distance between the wearable device 100 and an external object obtained through a depth sensor), using an image obtained through the photographing camera 1060-4. The wearable device 100 may perform object recognition through an image obtained using the photographing camera 1060-4. The wearable device 100 may perform a function (e.g., auto focus) of focusing an object (or subject) within an image and/or an optical image stabilization (OIS) function (e.g., an anti-shaking function) using the photographing camera 1060-4. While displaying a screen representing a virtual space on the at least one display 1050, the wearable device 100 may perform a pass through function for displaying an image obtained through the photographing camera 1060-4 overlapping at least a portion of the screen. In an embodiment, the photographing camera 1060-4 may be disposed on the bridge 1003 disposed between the first rim 1001 and the second rim 1002.

The eye tracking camera 1060-1 may implement a more realistic augmented reality by matching the user's gaze with the visual information provided on the at least one display 1050, by tracking the gaze of the user wearing the wearable device 100. For example, when the user looks at the front, the wearable device 100 may naturally display environment information associated with the user's front on the at least one display 1050 at a position where the user is positioned. The eye tracking camera 1060-1 may be configured to capture an image of the user's pupil in order to determine the user's gaze. For example, the eye tracking camera 1060-1 may receive gaze detection light reflected from the user's pupil and may track the user's gaze based on the position and movement of the received gaze detection light. In an embodiment, the eye tracking camera 1060-1 may be disposed at a position corresponding to the user's left and right eyes. For example, the eye tracking camera 1060-1 may be disposed in the first rim 1001 and/or the second rim 1002 to face the direction in which the user wearing the wearable device 100 is positioned.

The motion recognition camera 1060-2 and 1060-3 may provide a specific event to the screen provided on the at least one display 1050 by recognizing the movement of the whole or portion of the user's body, such as the user's torso, hand, or face. The motion recognition camera 1060-2 and 1060-3 may obtain a signal corresponding to motion by recognizing the user's motion (e.g., gesture recognition), and may provide a display corresponding to the signal to the at least one display 1050. The processor may identify a signal corresponding to the operation and may perform a preset function based on the identification. The motion recognition camera 1060-2 and 1060-3 may be used to perform simultaneous localization and mapping (SLAM) for 6 degrees of freedom pose (6 dof pose) and/or a space recognition function using a depth map. The processor may perform a gesture recognition function and/or an object tracking function, using the motion recognition camera 1060-2 and 1060-3. In an embodiment, the motion recognition camera 1060-2 and camera 1060-3 may be disposed on the first rim 1001 and/or the second rim 1002.

The camera 1060 included in the wearable device 100 is not limited to the above-described eye tracking camera 1060-1 and the motion recognition camera 1060-2 and 1060-3. For example, the wearable device 100 may identify an external object included in the FoV using a camera disposed toward the user's FoV. The wearable device 100 identifying the external object may be performed based on a sensor for identifying a distance between the wearable device 100 and the external object, such as a depth sensor and/or a time of flight (ToF) sensor. The camera 1060 disposed toward the FoV may support an autofocus function and/or an optical image stabilization (OIS) function. For example, in order to obtain an image including a face of the user wearing the wearable device 100, the wearable device 100 may include the camera 1060 (e.g., a face tracking (FT) camera) disposed toward the face.

Although not illustrated, the wearable device 100 according to an embodiment may further include a light source (e.g., LED) that emits light toward a subject (e.g., user's eyes, face, and/or an external object in the FoV) photographed using the camera 1060. The light source may include an LED having an infrared wavelength. The light source may be disposed on at least one of the frame 1000, and the hinge units 1006 and 1007.

According to an embodiment, the battery module 1070 may supply power to electronic components of the wearable device 100. In an embodiment, the battery module 1070 may be disposed in the first temple 1004 and/or the second temple 1005. For example, the battery module 1070 may be a plurality of battery modules 1070. The plurality of battery modules 1070, respectively, may be disposed on each of the first temple 1004 and the second temple 1005. In an embodiment, the battery module 1070 may be disposed at an end of the first temple 1004 and/or the second temple 1005.

The antenna module 1075 may include at least one antenna and transmit the signal or power to the outside of the wearable device 100 or may receive the signal or power from the outside. In an embodiment, the antenna module 1075 may be disposed in the first temple 1004 and/or the second temple 1005. For example, the antenna module 1075 may be disposed close to one surface of the first temple 1004 and/or the second temple 1005.

A speaker 1055 may output a sound signal to the outside of the wearable device 100. A sound output module may be referred to as a speaker. In an embodiment, the speaker 1055 may be disposed in the first temple 1004 and/or the second temple 1005 in order to be disposed adjacent to the ear of the user wearing the wearable device 100. For example, the speaker 1055 may include a second speaker 1055-2 disposed adjacent to the user's left ear by being disposed in the first temple 1004, and a first speaker 1055-1 disposed adjacent to the user's right ear by being disposed in the second temple 1005.

The light emitting module (not illustrated) may include at least one light emitting element. The light emitting module may emit light of a color corresponding to a specific state or may emit light through an operation corresponding to the specific state in order to visually provide information on a specific state of the wearable device 100 to the user. For example, when the wearable device 100 requires charging, it may emit red light at a constant cycle. In an embodiment, the light emitting module may be disposed on the first rim 1001 and/or the second rim 1002.

Referring to FIG. 10B, according to an embodiment, the wearable device 100 may include the printed circuit board (PCB) 1090. The PCB 1090 may be included in at least one of the first temple 1004 or the second temple 1005. The PCB 1090 may include an interposer disposed between at least two sub PCBs. On the PCB 1090, one or more hardware (e.g., hardware illustrated by the blocks described above with reference to FIG. 4) included in the wearable device 100 may be disposed. The wearable device 100 may include a flexible PCB (FPCB) for interconnecting the hardware.

According to an embodiment, the wearable device 100 may include at least one of a gyro sensor, a gravity sensor, and/or an acceleration sensor for detecting the posture of the wearable device 100 and/or the posture of a body part (e.g., a head) of the user wearing the wearable device 100. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 100 may identify the user's motion and/or gesture performed to execute or stop a specific function of the wearable device 100 based on the IMU.

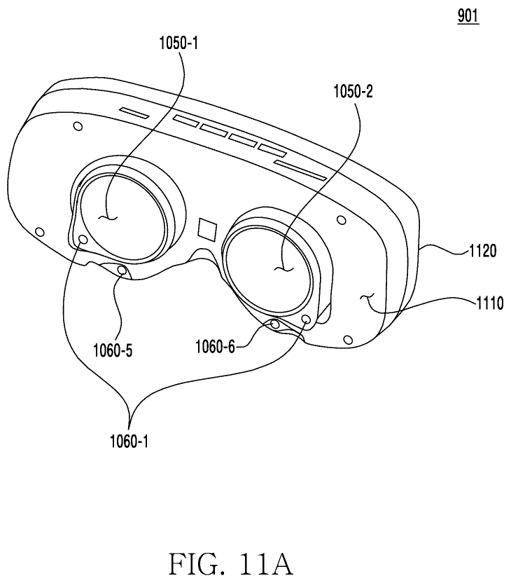

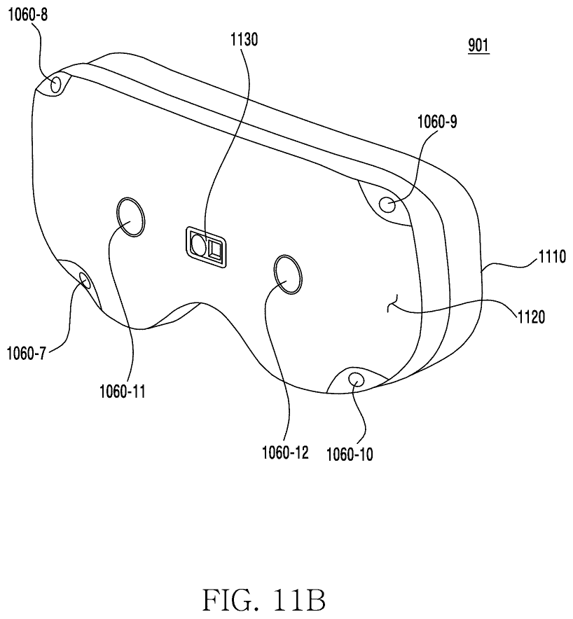

FIGS. 11A and 11B are perspective views illustrating an example of an exterior of a wearable device (e.g., the wearable device 100) according to various embodiments. The electronic device 901 of FIGS.

11A and 11B may be an example of the wearable device 100 of FIG. 1. According to an embodiment, an example of an exterior of a first surface 1110 of a housing of the wearable device 100 may be illustrated in FIG. 11A, and an example of an exterior of a second surface 1120 opposite to the first surface 1110 may be illustrated in FIG. 11B.

Referring to FIG. 11A, according to an embodiment, the first surface 1110 of the wearable device 100 may have an attachable shape on the user's body part (e.g., the user's face). Although not illustrated, the wearable device 100 may further include a strap for being fixed on the user's body part, and/or one or more temples (e.g., the first temple 1004 and/or the second temple 1005 of FIGS. 10A to 10B). A first display 1050-1 for outputting an image to the left eye among the user's two eyes and a second display 1050-2 for outputting an image to the right eye among the user's two eyes may be disposed on the first surface 1110. The wearable device 100 may further include rubber or silicon packing, which are formed on the first surface 1110, for preventing and/or reducing interference by light (e.g., ambient light) different from the light emitted from the first display 1050-1 and the second display 1050-2.

According to an embodiment, the wearable device 100 may include camera 1060-1 for photographing and/or tracking two eyes of the user adjacent to each of the first display 1050-1 and the second display 1050-2. The cameras 1060-1 may be referred to as the gaze tracking camera 1060-1 of FIG. 10B. According to an embodiment, the wearable device 100 may include cameras 1060-5 and 1060-6 for photographing and/or recognizing the user's face. The cameras 1060-5 and 1060-6 may be referred to as a FT camera. The wearable device 100 may control an avatar representing a user in a virtual space, based on a motion of the user's face identified using the cameras 1060-5 and 1060-6. For example, the wearable device 100 may change a texture and/or a shape of a portion (e.g., a portion of an avatar representing a human face) of the avatar, using information obtained by the cameras 1060-5 and 1060-6 (e.g., the FT camera) and representing the facial expression of the user wearing the wearable device 100.

Referring to FIG. 11B, a camera (e.g., cameras 1060-7, 1060-8, 1060-9, 1060-10, 1060-11, and 1060-12), and/or a sensor (e.g., the depth sensor 1130) for obtaining information associated with the external environment of the wearable device 100 may be disposed on the second surface 1120 opposite to the first surface 1110 of FIG. 11A. For example, the cameras 1060-7, 1060-8, 1060-9, and 1060-10 may be disposed on the second surface 1120 in order to recognize an external object. The cameras 1060-7, 1060-8, 1060-9, and 1060-10 may be referred to as the motion recognition cameras 1060-2 and 1060-3 of FIG. 10B.

For example, using cameras 1060-11 and 1060-12, the wearable device 100 may obtain an image and/or video to be transmitted to each of the user's two eyes. The camera 1060-11 may be disposed on the second surface 1120 of the wearable device 100 to obtain an image to be displayed through the second display 1050-2 corresponding to the right eye among the two eyes. The camera 1060-12 may be disposed on the second surface 1120 of the wearable device 100 to obtain an image to be displayed through the first display 1050-1 corresponding to the left eye among the two eyes. The cameras 1060-11 and 1060-12 may be referred to as the photographing camera 1060-4 of FIG. 10B.

According to an embodiment, the wearable device 100 may include the depth sensor 1130 disposed on the second surface 1120 in order to identify a distance between the wearable device 100 and the external object. Using the depth sensor 1130, the wearable device 100 may obtain spatial information (e.g., a depth map) about at least a portion of the FoV of the user wearing the wearable device 100. Although not illustrated, a microphone for obtaining sound output from the external object may be disposed on the second surface 1120 of the wearable device 100. The number of microphones may be one or more according to embodiments.

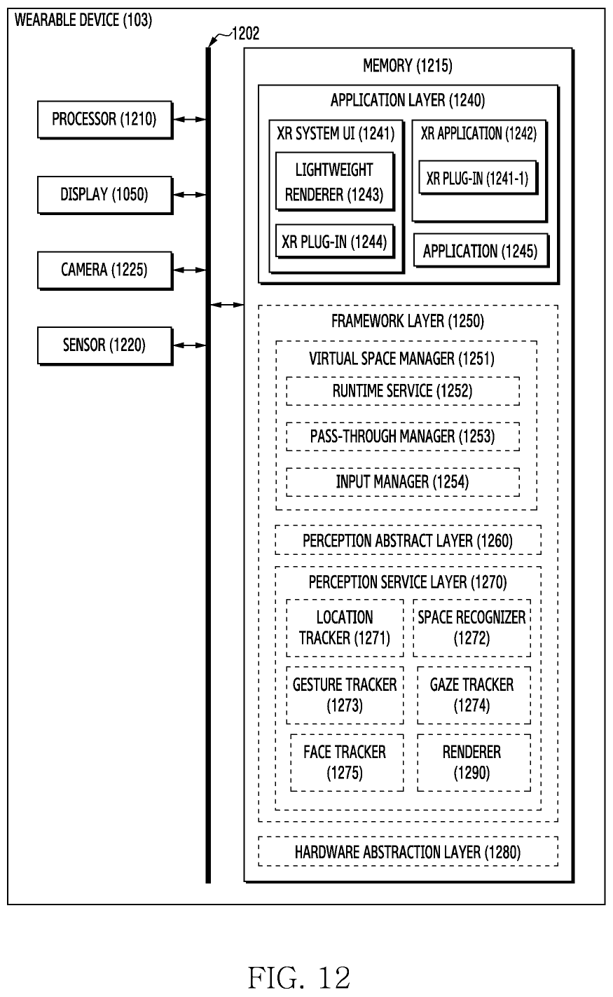

Hereinafter, a hardware or software configuration of the wearable device 100 will be described in greater detail with reference to FIG. 12.

FIG. 12 is a block diagram illustrating an example configuration of a wearable device (e.g., wearable device 100) according to various embodiments.

The wearable device 100 of FIG. 12 may be an example of the electronic device 100 of FIG. 1 and the electronic device 100 of FIGS. 10A, 10B, 11A and 11B.

Referring to FIG. 12, the wearable device 100 according to an embodiment may include a processor (e.g., including processing circuitry) 1210, memory 1215, a display 1050 (e.g., the first display 1050-1 and/or the second display 1050-2 of FIGS. 10A, 10B, 11A, and 11B) and/or a sensor 1220. The processor 1210, the memory 1215, the display 1050, and/or the sensor 1220 may be electrically and/or operably connected to each other by an electronic component such as a communication bus 1202. In the present disclosure, an operational connection of electronic components may include a direct connection established between the electronic components and/or an indirect connection established between the electronic components such that a first electronic component of the electronic components is controlled by a second electronic component of the electronic components. The type and/or number of electronic components included in the wearable device 100 is not limited as illustrated in FIG. 12. For example, the wearable device 100 may include only some of the electronic components illustrated in FIG. 12.

According to an embodiment, the processor 1210 of the wearable device 100 may include circuitry (e.g., processing circuitry) for processing data, based on one or more instructions. For example, the circuitry for processing data may include an arithmetic and logic unit (ALU), a field programmable gate array (FPGA), a central processing unit (CPU) and/or an application processor (AP). In an embodiment, the wearable device 100 may include one or more processors. The processor 1210 may have a structure of a multi-core processor such as a dual core, a quad core, a hexa core, and/or an octa core. The multi-core processor structure of the processor 1210 may include a structure (e.g., a big-little structure) based on a plurality of core circuits, divided by power consumption, clock, and/or computational amount per unit time. In an embodiment including the processor 1210 having a multi-core processor structure, operations and/or functions of the present disclosure may be performed individually or collectively by one or more cores included in the processor 1210.

According to an embodiment, the memory 1215 of the wearable device 100 may include an electronic component for storing data and/or instructions input to the processor 1210 and/or output from the processor 1210. For example, the memory 1215 may include a volatile memory such as a random-access memory (RAM) and/or a non-volatile memory such as a read-only memory (ROM). For example, the volatile memory may include at least one of a dynamic RAM (DRAM), a static RAM (SRAM), a cache RAM, and a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disc, and an embedded multi-media card (eMMC). In an embodiment, the memory 1215 may be referred to as a storage.

In an embodiment, the display 1050 of the wearable device 100 may output visualized information to a user of the wearable device 100. The display 1050 arranged in front of eyes of the user wearing the wearable device 100 may be disposed in at least a portion of a housing of the wearable device 100 (e.g., the first display 1050-1 and/or the second display 1050-2 of FIGS. 10A, 10B, 11A, and 11B). For example, the display 1050 may output visualized information to the user by being controlled by the processor 1210 including a circuit such as a CPU, a graphic processing unit (GPU), and/or a display processing unit (DPU). The display 1050 may include a flexible display, a flat panel display (FPD) and/or electronic paper. The display 1050 may include a liquid crystal display (LCD), a plasma display panel (PDP), and/or one or more light emitting diode (LED). The LED may include an organic LED (OLED). The disclosure is not limited thereto, and for example, the display 1050 may include a projector (or projection assembly) for projecting light onto the lens when the wearable device 100 includes a lens for transmitting external light (or ambient light). In an embodiment, the display 1050 may be referred to as a display panel and/or a display module. Pixels included in the display 1050 may be disposed toward any one of the user's two eyes when worn by the user of the wearable device 100. For example, the display 1050 may include display areas (or active areas) corresponding to each of the user's two eyes.

In an embodiment, the sensor 1220 of the wearable device 100 may generate electronic information capable of being processed by the processor 1210 and/or the memory 1215 from non-electronic information associated with the wearable device 100. For example, the sensor 1220 may include a global positioning system (GPS) sensor for detecting a geographic location of the wearable device 100. In addition to the GPS method, the sensor 1220 may generate information indicating a geographical location of the wearable device 100 based on a global navigation satellite system (GNSS), such as Galileo, Beidou, or Compass). The information may be stored in the memory 1215, processed by the processor 1210, and/or transmitted to another electronic device distinct from the wearable device 100 via a communication circuit.

According to an embodiment, one or more instructions (or commands) indicating data to be processed by the processor 1210 of the wearable device 100, calculations and/or operations to be performed may be stored in the memory 1215 of the wearable device 100. A set of one or more instructions may be referred to as a program, firmware, operating system, process, routine, sub-routine, and/or software application (hereinafter referred to as application). For example, the wearable device 100 and/or the processor 1210 may perform at least one of operations of FIG. 4, when a set of a plurality of instruction distributed in the form of an operating system, firmware, driver, program, and/or software application is executed. Hereinafter, a software application being installed within the wearable device 100 may mean that one or more instructions provided in the form of a software application (or package) being stored in the memory 1215, and that the one or more applications are stored in an executable format (e.g., a file with an extension designated by the operating system of the wearable device 100) by the processor 1210. As an example, the application may include a program and/or a library, associated with a service provided to a user.

Referring to FIG. 12, programs installed in the wearable device 100 may be included in any one among different layers including an application layer 1240, a framework layer 1250, and/or a hardware abstraction layer (HAL) 1280, based on a target. For example, programs (e.g., module or driver) designed to target a hardware (e.g., the display 1050, and/or the sensor 1220) of the wearable device 100 may be included in the hardware abstraction layer 1280. In terms of including one or more programs for providing an extended reality (XR) service, the framework layer 1250 may be referred to as an XR framework layer. For example, the layers illustrated in FIG. 12, which are logically separated (or for convenience of explanation), may not mean that an address space of the memory 1215 being divided by the layers.

For example, programs (e.g., location tracker 1271, space recognizer 1272, gesture tracker 1273, gaze tracker 1274, and/or face tracker 1275) designed to target at least one of the hardware abstraction layer 1280 and/or the application layer 1240 may be included within framework layer 1250. Programs included in the framework layer 1250 may provide an application programming interface (API) capable of being executed (or called) based on other programs.

For example, a program designed to target a user of the wearable device 100 may be included in the application layer 1240. An extended reality (XR) system user interface (UI) 1241 and/or an XR application 1242 are illustrated as an example of programs included in the application layer 1240, but embodiments are not limited thereto. For example, programs (e.g., software application) included in the application layer 1240 may cause execution of a function supported by programs included in the framework layer 1250, by calling the API.

For example, the wearable device 100 may display, on the display 1050, one or more visual objects for performing interaction with the user, based on the execution of the XR system UI 1241. The visual object may mean an object capable of being positioned within a screen for transmission of information and/or interaction, such as text, image, icon, video, button, check box, radio button, text box, slider and/or table. The visual object may be referred to as a visual guide, a virtual object, a visual element, a UI element, a view object, and/or a view element. The wearable device 100 may provide functions available in a virtual space to the user, based on the execution of the XR system UI 1241.

Referring to FIG. 12, it is described that the XR system UI 1241 includes a lightweight renderer 1243 and/or an XR plug-in 1244 but is not limited thereto. For example, the processor 1210 may execute the lightweight renderer 1243 and/or the XR plug-in 1244 in the framework layer 1250, based on the XR system UI 1241.

For example, the wearable device 100 may obtain a resource (e.g., API, system process, and/or library) used to define, create, and/or execute a rendering pipeline in which partial changes are allowed, based on the execution of the lightweight renderer 1243. The lightweight renderer 1243 may be referred to as a lightweight renderer pipeline in terms of defining a rendering pipeline in which partial changes are allowed. The lightweight renderer 1243 may include a renderer (e.g., a prebuilt renderer) built before execution of a software application. For example, the wearable device 100 may obtain a resource (e.g., API, system process, and/or library) used to define, create, and/or execute the entire rendering pipeline, based on the execution of the XR plug-in 1244. The XR plug-in 1244 may be referred to as an open XR native client in terms of defining (or setting) the entire rendering pipeline.

For example, the wearable device 100 may display a screen representing at least a portion of a virtual space on the display 1050, based on the execution of the XR application 1242. The XR plug-in 1244-1 included in the XR application 1242 may include instructions supporting a function similar to the XR plug-in 1244 of the XR system UI 1241. Among descriptions of the XR plug-in 1244-1, a description overlapping those of the XR plug-in 1244 may be omitted. The wearable device 100 may cause execution of a virtual space manager 1251, based on execution of the XR application 1242.

For example, the wearable device 100 may display an image in a virtual space on the display 1050, based on execution of an application 1245. The application 1245 may be configured to output image information for displaying a two-dimensional image. The wearable device 100 may cause execution of the virtual space manager 1251, based on execution of the application 1245. The wearable device 100 may create double image information to represent the two-dimensional image in a three-dimensional virtual space, based on the execution of the application 1245. Herein, the double image information may include first image information for the left eye and second image information for the right eye, in consideration of binocular disparity. In order to represent the two-dimensional image in the three-dimensional virtual space, the wearable device 100 may create the double image information, based on image information for displaying the two-dimensional image.

According to an embodiment, the wearable device 100 may provide a virtual space service, based on the execution of the virtual space manager 1251. For example, the virtual space manager 1251 may include a platform for supporting a virtual space service. Based on the execution of the virtual space manager 1251, the wearable device 100 may identify a virtual space formed based on a user's location indicated by data obtained through the sensor 1230, and may display at least a portion of the virtual space on the display 1050. The virtual space manager 1251 may be referred to as a composition presentation manager (CPM).

For example, the virtual space manager 1251 may include a runtime service 1252. As an example, the runtime service 1252 may be referred to as an OpenXR runtime module (or OpenXR runtime program). The wearable device 100 may execute at least one of a user's pose prediction function, a frame timing function, and/or a space input function, based on the execution of the runtime service 1252. As an example, the wearable device 100 may perform rendering for a virtual space service to a user, based on the execution of the runtime service 1252. For example, based on the execution of runtime service 1252, a function associated with a virtual space executable by the application layer 1240 may be supported.

For example, the virtual space manager 1251 may include a pass-through manager 1253. The wearable device 100 may display an image and/or a video representing an actual space obtained through an external camera superimposed on at least a portion of the screen, while displaying a screen representing a virtual space on display 1050, based on the execution of the pass-through manager 1253.

For example, the virtual space manager 1251 may include an input manager 1254. The wearable device 100 may identify data (e.g., sensor data) obtained by executing one or more programs included in a perception service layer 1270, based on the execution of the input manager 1254. The wearable device 100 may identify a user input associated with the wearable device 100, using the obtained data. The user input may be associated with the user's motion (e.g., hand gesture), gaze, and/or speech identified by the sensor 1220 (e.g., an image sensor 1230 such as an external camera). The user input may be identified based on an external electronic device connected (or paired) through a communication circuit.

For example, a perception abstract layer 1260 may be used for data exchange between the virtual space manager 1251 and the perception service layer 1270. In terms of being used for data exchange between the virtual space manager 1251 and the perception service layer 1270, the perception abstract layer 1260 may be referred to as an interface. As an example, the perception abstraction layer 1260 may be referred to as OpenPX. The perception abstraction layer 1260 may be used for a perception client and a perception service.

According to an embodiment, the perception service layer 1270 may include one or more programs for processing data obtained from the sensor 1220. One or more programs may include at least one of the location tracker 1271, the space recognizer 1272, the gesture tracker 1273, and/or the gaze tracker 1274. The type and/or number of one or more programs included in the perception service layer 1270 is not limited as illustrated in FIG. 12.

For example, the wearable device 100 may identify a posture of the wearable device 100 using the sensor 1230, based on the execution of the location tracker 1271. The wearable device 100 may identify 6 degrees of freedom pose (6 dof pose) of the wearable device 100, based on the execution of the location tracker 1271, using data obtained using an external camera (e.g., image sensor 1221) and/or an IMU (e.g., motion sensor 1222 including gyro sensor, acceleration sensor and/or geomagnetic sensor). The location tracker 1271 may be referred to as a head tracking (HeT) module (or a head tracker or head tracking program).

For example, the wearable device 100 may obtain information for providing a three-dimensional virtual space corresponding to a surrounding environment (e.g., external space) of the wearable device 100 (or a user of the wearable device 100), based on the execution of the space recognizer 1272. The wearable device 100 may reproduce the surrounding environment of the wearable device 100 in three dimensions, using data obtained using an external camera (e.g., image sensor 1221) based on the execution of the space recognizer 1272. The wearable device 100 may identify at least one of a plane, an inclination, and a step, based on the surrounding environment of the wearable device 100 reproduced in three dimensions based on the execution of the space recognizer 1272. The space recognizer 1272 may be referred to as a scene understanding (SU) module (or a scene recognition program).

For example, the wearable device 100 may identify (or recognize) a hand's pose and/or gesture of the user of the wearable device 100 based on the execution of the gesture tracker 1273. For example, the wearable device 100 may identify a pose and/or a gesture of the user's hand using data obtained from an external camera (e.g., image sensor 1221), based on the execution of the gesture tracker 1273. As an example, the wearable device 100 may identify a pose and/or a gesture of the user's hand, based on data (or image) obtained using an external camera based on the execution of the gesture tracker 1273. The gesture tracker 1273 may be referred to as a hand tracking (HaT) module (or a hand tracking program) and/or a gesture tracking module.

For example, the wearable device 100 may identify (or track) the movement of the user's eyes of the wearable device 100, based on the execution of the gaze tracker 1274. For example, the wearable device 100 may identify the movement of the user's eyes, using data obtained from a gaze tracking camera (e.g., image sensor 1221) based on the execution of the gaze tracker 1274. The gaze tracker 1274 may be referred to as an eye tracking (ET) module (or eye tracking program) and/or a gaze tracking module.

For example, the perception service layer 1270 of the wearable device 100 may further include the face tracker 1275 for tracking the user's face. For example, the wearable device 100 may identify (or track) the movement of the user's face and/or the user's facial expression, based on the execution of the face tracker 1275. The wearable device 100 may estimate the user's facial expression, based on the movement of the user's face based on the execution of the face tracker 1275. For example, the wearable device 100 may identify the movement of the user's face and/or the user's facial expression, based on data (e.g., image and/or video) obtained using a camera 1225 (e.g., a camera facing at least a portion of the user's face), based on the execution of the face tracker 1275.

Referring to FIG. 12, a renderer 1290 may include instructions for rendering images in a three-dimensional virtual space. The processor 1210 executing the renderer 1290 may obtain at least one image to be at least partially displayed on a display area of the display 1050 at a software application. For example, the processor 1210 executing the renderer 1290 may determine a location of an area to which an application (e.g., XR application 1242, application 1245) is to be rendered. The processor 1210 executing the renderer 1290 may create an image of the application to be displayed on the display 1050. The renderer 1290 may synthesize the images to create a composite image to be displayed on the display 1050.

For example, the processor 1210 executing the renderer 1290 may divide a display area of the display 1050 into a foveated portion (or may be referred to as a foveated area) and a peripheral portion (or may be referred to as a remaining area), using a gaze location calculated using the location tracker 1271 and/or the gaze tracker 1274. For example, the processor 1210 detecting coordinate values of the gaze location may determine a portion of the display area including the coordinate values as a foveated area. The DPU executing the renderer 1290 may obtain at least one image, corresponding to each of the foveated area and the remaining area, and having a size smaller than a size of the entire display area of the display 1050 or a resolution less than a resolution of the display area.

The processor 1210 executing the renderer 1290 may obtain or create a composite image to be displayed on the display 1050, by synthesizing an image corresponding to the foveated area and an image corresponding to a peripheral portion. For example, the processor 1210 may enlarge the image corresponding to the peripheral portion to a size of the entire display area of the display 1050, by performing upscaling. The processor 1210 may create a composite image to be displayed on the display 1050, by combine the image corresponding to the foveated area onto the enlarged image. The processor 1210 may mix the enlarged image and the image corresponding to the foveated area, by applying a visual effect such as blur along a boundary line of the image corresponding to the foveated area.

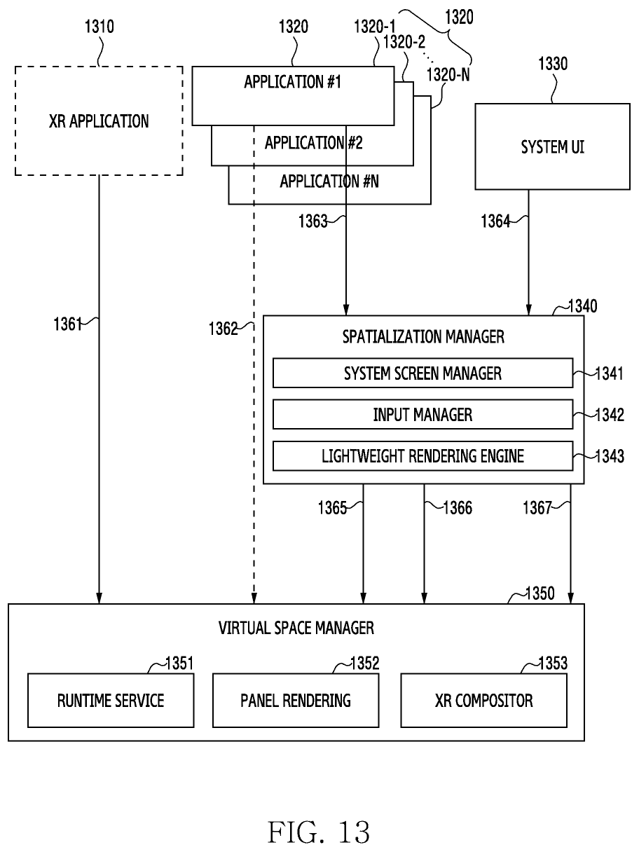

FIG. 13 is a block diagram illustrating an example configuration of an electronic device (e.g., electronic device 901, wearable device 100) for displaying an image in a virtual space according to various embodiments.

In FIG. 13, an example in which a plurality of programs/instructions for displaying an image in a virtual space is executed is described. The plurality of programs/instructions may all be executed in one processor (e.g., AP) or may be executed by a plurality of processors (e.g., AP, graphic processing unit (GPU), neural processing unit (NPU)). The meaning of being executable by the plurality of processors is that a portion of programs/instructions may be executed by a first processor, while another portion of programs/instructions may be executed by a second processor different from the first processor.

Referring to FIG. 13, the electronic device 901 may execute a virtual space manager 1350 (e.g., the virtual space manager 1251 and the CPM of FIG. 12) to render an image in a virtual space. For the virtual space manager 1350, descriptions of the virtual space manager 1251 of FIG. 12 may be at least partially referenced. The virtual space manager 1350 may include a platform for supporting a virtual space service. The virtual space manager 1350 may include a runtime service 1351 (e.g., OpenXR Runtime), a panel renderer 1352 (e.g., 2D Panel Render), and an XR compositor 1353. The electronic device 901 may execute at least one of a user's pose prediction function, a frame timing function, and/or a space input function, based on the execution of the runtime service 1351. For the runtime service 1351, descriptions of the runtime service 1252 of FIG. 12 may be at least partially referenced. The electronic device 901 may display at least one image (video) on a panel (e.g., a 2D panel) to implement a virtual space through a display, based on the execution of the panel rendering 1352. For example, the electronic device 901 may display a rendering image corresponding to RGB information 1366 for a panel from a spatialization manager 1340 to be described later via a display (e.g., display 1050). The electronic device 901 may synthesize an image of an actual area captured through a camera in a virtual space (hereinafter, a pass-through image) and a virtual area image, based on the execution of the XR compositor 1353. For example, the electronic device 901 may create a composite image, by merging the pass-through image and the virtual area image, based on the execution of the XR compositor 1353. The electronic device 901 may transmit the created composite image to a display buffer so that the composite image is displayed. The electronic device 901 may identify the virtual space through the virtual space manager 1350, and display at least a portion of the virtual space on the display 1050. The virtual space manager 1350 may be referred to as the CPM. The electronic device 901 may execute the virtual space manager 1350 to render an image corresponding to at least a portion of the virtual space.

According to an embodiment, the electronic device 901 may execute the spatialization manager 1340. The spatialization manager 1340 may perform processes for displaying an image in a three-dimensional virtual space. The electronic device 901 may perform preprocessing based on the execution of the spatialization manager 1340 so that an image may be rendered in a three-dimensional virtual space through the virtual space manager 1350. For example, the electronic device 901 may perform at least some of functions of the renderer 1290 of FIG. 12, based on the execution of the spatialization manager 1340. Based on the execution of the spatialization manager 1340, the electronic device 901 may process image information provided by an application (e.g., the XR application 1310, an application providing a normal two-dimensional screen other than XR, and an application that provides a system UI 1330). The spatialization manager 1340 (e.g., Space Flinger) may include a system screen manager 1341 (e.g., System scene), an input manager 1342 (e.g., Input Routing), and a lightweight rendering engine 1343 (e.g., Impress Engine). The system screen manager 1341 may be executed to display the system UI 1330. System UI-related information 1364 may be transmitted from a program (e.g., API) providing the system UI 1330 to the system screen manager 1341. The system UI-related information 1364 may be obtained via a spatializer API and/or a Same-process private API. The spatialization manager 1340 may determine a layout (e.g., location, display order) of a screen of the system UI 1330 in a three-dimensional space, through pre-allocated resources. The system screen manager 1341 may transmit image information 1367 for rendering a screen of the system UI 1330 to the virtual space manager 1350, according to the layout. The input manager 1342 may be configured to process a user input (e.g., user input on a system screen or an app screen). The impress engine 1343 may be a renderer (e.g., the lightweight renderer 1243) for creating an image. For example, the impress engine 1343 may be used to display the system UI 1330. According to an embodiment, the spatialization manager 1340 may include the lightweight rendering engine 1343 for rendering the system UI. According to an embodiment, in case that the lightweight rendering engine 1343 does not have enough resources to render an avatar used in the HMD, at least one external rendering engine may be used. In this case, in order to address the compatibility issue with external rendering (e.g., 3rd party engine), an external rendering engine support module may be added inside the spatialization manager 1340.

According to an embodiment, the electronic device may execute an application. For example, the virtual space manager 1350 may be executed in response to the execution of the XR application 1310 (e.g., the XR application 1242, 3D game, XR map, and other immersive application). The electronic device 901 may provide the virtual space manager 1350 with double image information 1361 provided from the XR application 1310. In order to display an image in a three-dimensional space, the double image information 1361 may include two image information considering binocular disparity. For example, the double image information 1361 may include first image information for the user's left eye and second image information for the user's right eye for rendering in a three-dimensional virtual space. Hereinafter, in the present disclosure, double image information is used as a term referring to image information for indicating images for two eyes in a three-dimensional space. In addition to the double image information, binocular image information, double image information, double image data, double image, binocular image data, stereoscopic image information, 3D image information, spatial image information, spatial image data, 2D-3D conversion data, dimensional conversion image data, binocular disparity image data, and/or equivalent technical terms may be used. The electronic device 901 may create a composite image by merging image layers via the virtual space manager 1350. The electronic device 901 may transmit the created composite image to a display buffer. The composite image may be displayed on the display 1050 of the electronic device 901.

According to an embodiment, the electronic device may execute at least one of an application 1320 (e.g., first application 1320-1, second application 1320-2, . . . , and Nth application 1320-N) different from the XR application 1310. According to an embodiment, the application 1320 may be configured to output image information for displaying a two-dimensional image. In other words, the application 1320 may provide a two-dimensional image. As an example, the application 1320 may be an image application, a schedule application, or an Internet browser application. If, in response to the execution of the application 1320, assume that image information 1362 provided from the application 1320 is provided to the virtual space manager 1350. Since the image information 1362 has only the x-coordinate and y-coordinate in the two-dimensional plane, it may be difficult to consider the order of precedence (e.g., a distance separated from the user) between other applications centered on the user. Even when displaying the application 1320 providing a general 2D screen, the electronic device 901 may execute the spatialization manager 1340 to provide double image information to the virtual space manager 1350. For example, the electronic device 901 may receive application-related information 1363 from the first application 1320-1, based on the execution of the spatialization manager 1340. For example, the application-related information 1363 may include image information (e.g., information including RGB per pixel) indicating a two-dimensional image of the first application 1320-1 and/or content information (e.g., characteristic of content executed in the first application, type of content) in the first application 1320-1. The application-related information 1363 may be obtained through a spatializer API. Based on the execution of the spatialization manager 1340, the electronic device 901 may identify a location of an area in which the first application 1320-1 is to be rendered and information (hereinafter, location information) on a size of the area to be rendered. Based on the execution of the spatialization manager 1340, the electronic device 901 may create double image information 1365 (e.g., RGBx2) in which the user's binocular disparity is considered, through the image information and the location information. Based on the execution of the spatialization manager 1340, the electronic device 901 may provide the double image information 1365 to the virtual space manager 1350. By converting a simple two-dimensional image into the double image information 1365, a problem occurring when the image information 1362 is directly transmitted to the virtual space manager 1350 may be addressed. In addition, as at least some of functions for image display in a virtual space are performed by the spatialization manager 1340 instead of the virtual space manager 1350, the burden on the virtual space manager 1350 may be reduced.

As described above, a wearable device may comprise memory (e.g., the memory 306) storing instructions. The wearable device may comprise at least one first camera (e.g., the at least one first camera 309). The wearable device may comprise at least one second camera (e.g., the at least one second camera 310). The wearable device may comprise a display assembly (e.g., the display assembly 308) including at least one display including a display region. The wearable device may comprise at least one processor (e.g., the at least one processor 307). The instructions, when executed by the at least one processor individually or collectively, may cause the wearable device to identify an event for displaying a screen generated using an image obtained through the at least one first camera. The instructions, when executed by the at least one processor individually or collectively, may cause the wearable device to, based on the event for displaying the screen within at least a portion of the display region where a gaze of a user (e.g., the user 120) identified through the at least one second camera is located, according to rendering the image using depth values (e.g., the depth value 550-1 to the depth value 550-5) obtained with respect to obtaining the image, display, within the at least a portion of the display region, the screen. The instructions, when executed by the at least one processor individually or collectively, may cause the wearable device to, based on the event for displaying the screen outside of the at least a portion of the display region where the gaze identified through the at least one second camera is located, according to rendering the image using a portion of the depth values, display, outside of the at least a portion of the display region, the screen.

According to an embodiment, the instructions, when executed by the at least one processor individually or collectively, may cause the wearable device to, based on the event for displaying the screen within the at least a portion of the display region where the gaze of the user identified through the at least one second camera is located, according to rendering the image by applying a first depth value (e.g., the depth value 550-1) for a first visual object (e.g., the visual object 240) included in the image to the first visual object and applying a second depth value (e.g., the depth value 550-2) for a second visual object (e.g., the visual object 250) included in the image to the second visual object, display, within the at least a portion of the display region, the screen. The instructions, when executed by the at least one processor individually or collectively, may cause the wearable device to, based on the event for displaying the screen outside of the at least a portion of the display region where the gaze identified through the at least one second camera is located, according to rendering the image by applying the first depth value among the first depth value for the first visual object and the second depth value for the second visual object to the first visual object and the second visual object, display, outside of the at least a portion of the display region, the screen.

According to an embodiment, the instructions, when executed by the at least one processor individually or collectively, may cause the wearable device to, based on the event for displaying the screen within the at least a portion of the display region where the gaze of the user identified through the at least one second camera is located, according to rendering the image further using a denoising filter configured to remove noise and a sharpening filter configured to improve sharpness of a screen, display, within the at least a portion of the display region, the screen. The instructions, when executed by the at least one processor individually or collectively, may cause the wearable device to, based on the event for displaying the screen outside of the at least a portion of the display region where the gaze identified through the at least one second camera is located, according to rendering the image using another denoising filter configured to perform less denoising than the denoising filter and another sharpening filter configured to perform less sharpening than the sharpening filter, display, outside of the at least portion of the display region, the screen.

According to an embodiment, the instructions, when executed by the at least one processor individually or collectively, may cause the wearable device to, based on the event that a distance between the user of the wearable device and a boundary of a recommended region (e.g., the recommended region 610) recommended for movement of the user is less than a threshold distance, according to rendering the image using the depth values obtained with respect to obtaining the image, display, within the at least a portion of the display region, the screen.

According to an embodiment, the instructions, when executed by the at least one processor individually or collectively, may cause the wearable device to, while content (e.g., the content 220) is displayed outside of the at least a portion of the display region where the gaze identified through the at least one second camera is located, based on the event for displaying the screen outside of the at least a portion of the display region, according to rendering the image using the portion of the depth values, display, outside of the at least a portion of the display region, the screen.

According to an embodiment, the wearable device may further include a sensor configured to detect movement of the wearable device. The instructions, when executed by the at least one processor individually or collectively, may cause the wearable device to: obtain, through the sensor, movement data of the wearable device. The instructions, when executed by the at least one processor individually or collectively, may cause the wearable device to identify the event for displaying the screen generated using the image obtained through the at least one camera and the movement data.

According to an embodiment, the instructions, when executed by the at least one processor individually or collectively, may cause the wearable device to, based on the event for displaying the screen outside of the at least a portion of the display region where the gaze identified through the at least one second camera is located, decrease frames per second (FPS) of the at least one first camera to reduce power consumed by the at least one first camera.

As described above, a method executed in a wearable device (e.g., the wearable device 100) with at least one first camera (e.g., the at least one first camera 309), at least one second camera (e.g., the at least one second camera 310), and display assembly (e.g., the display assembly 380) including at least one display including a display region may comprise identifying an event for displaying a screen generated using an image obtained through the at least one first camera. The method may comprise, based on the event for displaying the screen within at least a portion of the display region where a gaze of a user (e.g., the user 120) identified through the at least one second camera is located, according to rendering the image using depth values (e.g., the depth value 550-1 to the depth value 550-5) obtained with respect to obtaining the image, displaying, within the at least a portion of the display region, the screen. The method may comprise, based on the event for displaying the screen outside of the at least a portion of the display region where the gaze identified through the at least one second camera is located, according to rendering the image using a portion of the depth values, displaying, outside of the at least a portion of the display region, the screen.

According to an embodiment, the method may comprise: based on the event for displaying the screen within the at least a portion of the display region where the gaze of the user identified through the at least one second camera is located, according to rendering the image by applying a first depth value (e.g., the depth value 550-1) for a first visual object (e.g., the visual object 240) included in the image to the first visual object and applying a second depth value (e.g., the depth value 550-2) for a second visual object (e.g., the visual object 250) included in the image to the second visual object, displaying, within the at least a portion of the display region, the screen. The method may comprise, based on the event for displaying the screen outside of the at least a portion of the display region where the gaze identified through the at least one second camera is located, according to rendering the image by applying the first depth value among the first depth value for the first visual object and the second depth value for the second visual object to the first visual object and the second visual object, displaying, outside of the at least a portion of the display region, the screen.

According to an embodiment, the method may comprise: based on the event for displaying the screen within the at least a portion of the display region where the gaze of the user identified through the at least one second camera is located, according to rendering the image further using a denoising filter configured to remove noise and a sharpening filter configured to improve sharpness of a screen, displaying, within the at least a portion of the display region, the screen. The method may comprise, based on the event for displaying the screen outside of the at least a portion of the display region where the gaze identified through the at least one second camera is located, according to rendering the image using another denoising filter configured to perform less denoising than the denoising filter and another sharpening filter configured to perform less sharpening than the sharpening filter, displaying, outside of the at least portion of the display region, the screen.

According to an embodiment, the method may comprise, based on the event that a distance between the user of the wearable device and a boundary of a recommended region (e.g., the recommended region 610) recommended for movement of the user is less than a threshold distance, according to rendering the image using the depth values obtained with respect to obtaining the image, displaying, within the at least a portion of the display region, the screen.

According to an embodiment, the method may comprise, while content (e.g., the content 220) is displayed outside of the at least a portion of the display region where the gaze identified through the at least one second camera is located, based on the event for displaying the screen outside of the at least a portion of the display region, according to rendering the image using the portion of the depth values, displaying, outside of the at least a portion of the display region, the screen.

According to an embodiment, the wearable device may further include a sensor configured to detect movement of the wearable device. The method may comprise obtaining, through the sensor, movement data of the wearable device. The method may comprise identifying the event for displaying the screen generated using the image obtained through the at least one camera and the movement data.

According to an embodiment, the method may comprise, based on the event for displaying the screen outside of the at least a portion of the display region where the gaze identified through the at least one second camera is located, decreasing frames per second (FPS) of the at least one first camera to reduce power consumed by the at least one first camera.

As described above, a non-transitory computer readable storage medium storing one or more programs, the one or more programs may comprise instructions to, when executed by a wearable device (e.g., the wearable device 100) with at least one first camera (e.g., the at least one first camera 309), at least one second camera (e.g., the at least one second camera 310), and display assembly (e.g., the display assembly 380) including at least one display including a display region, cause the wearable device to identify an event for displaying a screen generated using an image obtained through the at least one first camera. The one or more programs may comprise instructions to, when executed by the wearable device, cause the wearable device to, based on the event for displaying the screen within at least a portion of the display region where a gaze of a user (e.g., the user 120) identified through the at least one second camera is located, according to rendering the image using depth values (e.g., the depth value 550-1 to the depth value 550-5) obtained with respect to obtaining the image, display, within the at least a portion of the display region, the screen. The one or more programs may comprise instructions to, when executed by the wearable device, cause the wearable device to, based on the event for displaying the screen outside of the at least a portion of the display region where the gaze identified through the at least one second camera is located, according to rendering the image using a portion of the depth values, display, outside of the at least a portion of the display region, the screen.

According to an embodiment, the one or more programs may comprise instructions to, when executed by the wearable device, cause the wearable device to, based on the event for displaying the screen within the at least a portion of the display region where the gaze of the user identified through the at least one second camera is located, according to rendering the image by a first depth value (e.g., the depth value 550-1) for a first visual object (e.g., the visual object 240) included in the image to the first visual object and applying a second depth value (e.g., the depth value 550-2) for a second visual object (e.g., the visual object 250) included in the image to the second visual object, display, within the at least a portion of the display region, the screen. The one or more programs may comprise instructions to, when executed by the wearable device, cause the wearable device to, based on the event for displaying the screen outside of the at least a portion of the display region where the gaze identified through the at least one second camera is located, according to rendering the image by applying the first depth value among the first depth value for the first visual object and the second depth value for the second visual object to the first visual object and the second visual object, display, outside of the at least a portion of the display region, the screen.

According to an embodiment, the one or more programs may comprise instructions to, when executed by the wearable device, cause the wearable device to, based on the event for displaying the screen within the at least a portion of the display region where the gaze of the user identified through the at least one second camera is located, according to rendering the image further using a denoising filter configured to remove noise and a sharpening filter configured to improve sharpness of a screen, display, within the at least a portion of the display region, the screen. The one or more programs may comprise instructions to, when executed by the wearable device, cause the wearable device to, based on the event for displaying the screen outside of the at least a portion of the display region where the gaze identified through the at least one second camera is located, according to rendering the image using another denoising filter configured to perform less denoising than the denoising filter and another sharpening filter configured to perform less sharpening than the sharpening filter, display, outside of the at least portion of the display region, the screen.

According to an embodiment, the one or more programs may comprise instructions to, when executed by the wearable device, cause the wearable device to, based on the event that a distance between the user of the wearable device and a boundary of a recommended region (e.g., the recommended region 610) recommended for movement of the user is less than a threshold distance, according to rendering the image using the depth values obtained with respect to obtaining the image, display, within the at least a portion of the display region, the screen.

According to an embodiment, the one or more programs may comprise instructions to, when executed by the wearable device, cause the wearable device to, while content (e.g., the content 220) is displayed outside of the at least a portion of the display region where the gaze identified through the at least one second camera is located, based on the event for displaying the screen outside of the at least a portion of the display region, according to rendering the image using the portion of the depth values, display, outside of the at least a portion of the display region, the screen.

According to an embodiment, the wearable device may further include a sensor configured to detect movement of the wearable device. The one or more programs may comprise instructions to, when executed by the wearable device, cause the wearable device to: obtain, through the sensor, movement data of the wearable device. The one or more programs may comprise instructions to, when executed by the wearable device, cause the wearable device to identify the event for displaying the screen generated using the image obtained through the at least one camera and the movement data.

According to an embodiment, the one or more programs may comprise instructions to, when executed by the wearable device, cause the wearable device to, based on the event for displaying the screen outside of the at least a portion of the display region where the gaze identified through the at least one second camera is located, decrease frames per second (FPS) of the at least one first camera to reduce power consumed by the at least one first camera.

The device described above may be implemented as a hardware component, a software component, and/or a combination of a hardware component and a software component. For example, the devices and components described in the various embodiments may be implemented using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to an example embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although various embodiments have been described with limited examples and drawings, a person who has ordinary knowledge in the relevant technical field is capable of various modifications and transformations from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, various embodiments are included in the scope of the disclosure, including the appended claims and their equivalents. It will also be understood that any of the embodiment(s) described herein may be used in conjunction with any other embodiment(s) described herein. According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable device comprising:
memory, comprising one or more storage mediums, storing instructions;
at least one first camera;
at least one second camera;
display assembly including at least one display including a display region; and
at least one processor comprising processing circuitry,
wherein the instructions, when executed by the at least one processor individually or collectively, cause the wearable device to:
identify an event for displaying a screen generated using an image obtained through the at least one first camera,
based on the event for displaying the screen within at least a portion of the display region where a gaze of a user identified through the at least one second camera is located, according to rendering the image using depth values obtained with respect to obtaining the image, display, within the at least a portion of the display region, the screen, and
based on the event for displaying the screen outside of the at least a portion of the display region where the gaze identified through the at least one second camera is located, according to rendering the image using a portion of the depth values, display, outside of the at least a portion of the display region, the screen.

2. The wearable device of claim 1, wherein the instructions, when executed by the at least one processor individually or collectively, cause the wearable device to:
based on the event for displaying the screen within the at least a portion of the display region where the gaze of the user identified through the at least one second camera is located, according to rendering the image by applying a first depth value for a first visual object included in the image to the first visual object and applying a second depth value for a second visual object included in the image to the second visual object, display, within the at least a portion of the display region, the screen, and
based on the event for displaying the screen outside of the at least a portion of the display region where the gaze identified through the at least one second camera is located, according to rendering the image by applying the first depth value among the first depth value for the first visual object and the second depth value for the second visual object to the first visual object and the second visual object, display, outside of the at least a portion of the display region, the screen.

3. The wearable device of claim 1, wherein the instructions, when executed by the at least one processor individually or collectively, cause the wearable device to:
based on the event for displaying the screen within the at least a portion of the display region where the gaze of the user identified through the at least one second camera is located, according to rendering the image further using a denoising filter configured to remove noise and a sharpening filter configured to improve sharpness of a screen, display, within the at least a portion of the display region, the screen, and
based on the event for displaying the screen outside of the at least a portion of the display region where the gaze identified through the at least one second camera is located, according to rendering the image using another denoising filter configured to perform less denoising than the denoising filter and another sharpening filter configured to perform less sharpening than the sharpening filter, display, outside of the at least portion of the display region, the screen.

4. The wearable device of claim 1, wherein the instructions, when executed by the at least one processor individually or collectively, cause the wearable device to:
based on the event that a distance between the user of the wearable device and a boundary of a recommended region recommended for movement of the user is less than a threshold distance, according to rendering the image using the depth values obtained with respect to obtaining the image, display, within the at least a portion of the display region, the screen.

5. The wearable device of claim 1, wherein the instructions, when executed by the at least one processor individually or collectively, cause the wearable device to:
while content is displayed outside of the at least a portion of the display region where the gaze identified through the at least one second camera is located, based on the event for displaying the screen outside of the at least a portion of the display region, according to rendering the image using the portion of the depth values, display, outside of the at least a portion of the display region, the screen.

6. The wearable device of claim 1, wherein the wearable device further includes a sensor configured to detect movement of the wearable device,
wherein the instructions, when executed by the at least one processor individually or collectively, cause the wearable device to:
obtain, through the sensor, movement data of the wearable device, and
identify the event for displaying the screen generated using the image obtained through the at least one camera and the movement data.

7. The wearable device of claim 1, wherein the instructions, when executed by the at least one processor individually or collectively, cause the wearable device to:
based on the event for displaying the screen outside of the at least a portion of the display region where the gaze identified through the at least one second camera is located, decrease frames per second (FPS) of the at least one first camera to reduce power consumed by the at least one first camera.

8. A method executed in a wearable device with at least one first camera, at least one second camera, and display assembly including at least one display including a display region, the method comprising:
identifying an event for displaying a screen generated using an image obtained through the at least one first camera,
based on the event for displaying the screen within at least a portion of the display region where a gaze of a user identified through the at least one second camera is located, according to rendering the image using depth values obtained with respect to obtaining the image, displaying, within the at least a portion of the display region, the screen, and
based on the event for displaying the screen outside of the at least a portion of the display region where the gaze identified through the at least one second camera is located, according to rendering the image using a portion of the depth values, displaying, outside of the at least a portion of the display region, the screen.

9. The method of claim 8, further comprising:
based on the event for displaying the screen within the at least a portion of the display region where the gaze of the user identified through the at least one second camera is located, according to rendering the image by applying a first depth value for a first visual object included in the image to the first visual object and applying a second depth value for a second visual object included in the image to the second visual object, displaying, within the at least a portion of the display region, the screen, and
based on the event for displaying the screen outside of the at least a portion of the display region where the gaze identified through the at least one second camera is located, according to rendering the image by applying the first depth value among the first depth value for the first visual object and the second depth value for the second visual object to the first visual object and the second visual object, displaying, outside of the at least a portion of the display region, the screen.

10. The method of claim 8, further comprising:
based on the event for displaying the screen within the at least a portion of the display region where the gaze of the user identified through the at least one second camera is located, according to rendering the image further using a denoising filter configured to remove noise and a sharpening filter configured to improve sharpness of a screen, displaying, within the at least a portion of the display region, the screen, and
based on the event for displaying the screen outside of the at least a portion of the display region where the gaze identified through the at least one second camera is located, according to rendering the image using another denoising filter configured to perform less denoising than the denoising filter and another sharpening filter configured to perform less sharpening than the sharpening filter, displaying, outside of the at least portion of the display region, the screen.

11. The method of claim 8, further comprising:
based on the event that a distance between the user of the wearable device and a boundary of a recommended region recommended for movement of the user is less than a threshold distance, according to rendering the image using the depth values obtained with respect to obtaining the image, displaying, within the at least a portion of the display region, the screen.

12. The method of claim 8, further comprising:
while content is displayed outside of the at least a portion of the display region where the gaze identified through the at least one second camera is located, based on the event for displaying the screen outside of the at least a portion of the display region, according to rendering the image using the portion of the depth values, displaying, outside of the at least a portion of the display region, the screen.

13. The method of claim 8, wherein the wearable device further includes a sensor configured to detect movement of the wearable device, and
wherein the method further comprising:
obtaining, through the sensor, movement data of the wearable device, and
identifying the event for displaying the screen generated using the image obtained through the at least one camera and the movement data.

14. The method of claim 8, further comprising:
based on the event for displaying the screen outside of the at least a portion of the display region where the gaze identified through the at least one second camera is located, decreasing frames per second (FPS) of the at least one first camera to reduce power consumed by the at least one first camera.

15. Anon-transitory computer readable storage medium storing one or more programs, the one or more programs comprising instructions to, when executed by a wearable device with at least one first camera, at least one second camera, and display assembly including at least one display including a display region, cause the wearable device to:
identify an event for displaying a screen generated using an image obtained through the at least one first camera,
based on the event for displaying the screen within at least a portion of the display region where a gaze of a user identified through the at least one second camera is located, according to rendering the image using depth values obtained with respect to obtaining the image, display, within the at least a portion of the display region, the screen, and
based on the event for displaying the screen outside of the at least a portion of the display region where the gaze identified through the at least one second camera is located, according to rendering the image using a portion of the depth values, display, outside of the at least a portion of the display region, the screen.

16. The non-transitory computer readable storage medium of claim 15,
wherein the one or more programs comprise instructions that, when executed by at least one processor, individually and/or collectively, of the wearable device, cause the wearable device to:
based on the event for displaying the screen within the at least a portion of the display region where the gaze of the user identified through the at least one second camera is located, according to rendering the image by applying a first depth value for a first visual object included in the image to the first visual object and applying a second depth value for a second visual object included in the image to the second visual object, display, within the at least a portion of the display region, the screen, and
based on the event for displaying the screen outside of the at least a portion of the display region where the gaze identified through the at least one second camera is located, according to rendering the image by applying the first depth value among the first depth value for the first visual object and the second depth value for the second visual object to the first visual object and the second visual object, display, outside of the at least a portion of the display region, the screen.

17. The non-transitory computer readable storage medium of claim 15,
wherein the one or more programs comprise instructions to, when executed by the wearable device, cause the wearable device to:
based on the event for displaying the screen within the at least a portion of the display region where the gaze of the user identified through the at least one second camera is located, according to rendering the image further using a denoising filter configured to remove noise and a sharpening filter configured to improve sharpness of a screen, display, within the at least a portion of the display region, the screen, and
based on the event for displaying the screen outside of the at least a portion of the display region where the gaze identified through the at least one second camera is located, according to rendering the image using another denoising filter configured to perform less denoising than the denoising filter and another sharpening filter configured to perform less sharpening than the sharpening filter, display, outside of the at least portion of the display region, the screen.

18. The non-transitory computer readable storage medium of claim 15,
wherein the one or more programs comprise instructions to, when executed by the wearable device, cause the wearable device to:
based on the event that a distance between the user of the wearable device and a boundary of a recommended region recommended for movement of the user is less than a threshold distance, according to rendering the image using the depth values obtained with respect to obtaining the image, display, within the at least a portion of the display region, the screen.

19. The non-transitory computer readable storage medium of claim 15,
wherein the one or more programs comprise instructions to, when executed by the wearable device, cause the wearable device to:
while content is displayed outside of the at least a portion of the display region where the gaze identified through the at least one second camera is located, based on the event for displaying the screen outside of the at least a portion of the display region, according to rendering the image using the portion of the depth values, display, outside of the at least a portion of the display region, the screen.

20. The non-transitory computer readable storage medium of claim 15, wherein the wearable device further includes a sensor configured to detect movement of the wearable device, and
wherein the one or more programs comprise instructions to, when executed by the wearable device, cause the wearable device to:
obtain, through the sensor, movement data of the wearable device, and
identify the event for displaying the screen generated using the image obtained through the at least one camera and the movement data.
